(19) United States
(12) Patent Application Publication
(10) Pub. No.: US 2026/0302991 A1
(43) Pub. Date: Oct. 1, 2026

(54) OPTIMIZED CONTROL FOR DUAL WOUND SYNCHRONOUS MOTOR DRIVES WITH ASYMMETRIC SUPPLY VOLTAGES

(71) Applicant: Steering Solutions IP Holding Corporation, Saginaw, MI (US)

(72) Inventors: Prerit Pramod, Saginaw, MI (US); Prathima Nuli, Troy, MI (US); Krishna MPK Namburi, Troy, MI (US)

(21) Appl. No.: 19/088,428

(22) Filed: Mar. 24, 2025

(51) Int. Cl. H02P 25/022; B62D 5/04; H02P 21/22; H02P 25/22; H02P 27/06

(52) U.S. Cl. CPC H02P 25/022; H02P 21/22; H02P 25/22; H02P 27/06; B62D 5/046; H02P 2207/05

(57) ABSTRACT

A method of controlling a dual wound synchronous machine (DWSM) includes: determining a positive virtual lower voltage limit based on a first DC supply voltage and a second DC supply voltage; determining, based on the positive virtual lower voltage limit, a maximum torque for symmetric operation; determining, based on the maximum torque for symmetric operation, a requirement for asymmetric currents to operate the DWSM in accordance with a torque command; determining, based on the positive virtual lower voltage limit, and in response to the requirement for asymmetric currents, a set of final asymmetric motor current commands; determining first and second final current commands by applying a mathematical transformation to the set of final asymmetric motor current commands; and commanding first and second inverters to apply corresponding first and second output voltages to corresponding ones of the first and second winding sets.

### BACKGROUND OF THE INVENTION

Dual wound synchronous machines, also called dual winding synchronous machines, are electric machines with two electrically independent sets of stator windings. Such dual wound synchronous machines may be used as motors, generators, or as motor/generators. Each set of stator windings may function independently as a corresponding half-motor and may be powered by a corresponding inverter. Such dual wound motors may be used in a variety of applications and can provide redundancy for safety-critical applications to allow continued operation in the event of a loss of one of the sets of stator windings and/or one of the inverters.

Dual wound synchronous machines, including dual wound permanent magnet synchronous machines (DW-PMSMs), inherently have electromagnetic (inductive) coupling between the two sets of stator windings (i.e., coupling between electrical circuits due to induction caused by magnetic fields generated as a result of the currents flowing through each of the two sets of stator windings). This induction results in a dependence of the currents, and thus torque, produced by the two winding sets of the dual wound machine. The extent or significance of this coupling depends on the specific design of the electric machine and particularly on specific features of the design including, but not limited to, stator slots, rotor poles, placement of magnets and winding configuration.

Conventional applications utilizing DW-PMSMs do not typically consider the inductive coupling between the two half-motors as significant and the resulting hardware topologies of the electric motor drive system as well as the control algorithms employed therein produce sub-optimal performance.

DW-PMSMs may be fed from two separate and independent DC power sources, which may have different voltages. Conventional solutions may not account for different voltages of the separate and independent DC power sources, which may result in sub-optimal operation and/or an inability to operate the DW-PMSM to produce the most torque possible for a given condition.

### SUMMARY OF THE INVENTION

In one embodiment of the invention, a method of controlling a dual wound synchronous machine (DWSM) having a first winding set and a second winding set is provided. The method comprises: determining a positive virtual lower voltage limit (V_{pL}) based on a first DC supply voltage and a second DC supply voltage; determining, based on the positive virtual lower voltage limit (V_{pL}), a maximum torque for symmetric operation (T_{epkLP}, T_{epkLN}); determining, based on the maximum torque for symmetric operation (T_{epkLP}, T_{epkLN}), a requirement for asymmetric currents to operate the DWSM in accordance with a torque command

$$( {T}_{e}^{*} ) ;$$

determining, based on the positive virtual lower voltage limit (V_{pL}), and in response to the requirement for asymmetric currents, a set of final asymmetric motor current commands; determining a first final current command

$$( {I}_{d 1}^{*} , {I}_{q 1}^{*} )$$

and a second final current command

$$( {I}_{d 2}^{*} , {I}_{q 2}^{*} )$$

by applying a mathematical transformation to the set of final asymmetric motor current commands; commanding, based on the first final current command

$$( {I}_{d 1}^{*} , {I}_{q 1}^{*} ) ,$$

a first inverter to apply a first output voltage to the first winding set and thereby causing a first output current to be generated in the first winding set in accordance with the first final current command

$$( {I}_{d 1}^{*} , {I}_{q 1}^{*} ) ;$$

and commanding, based on the second final current command

$$( {I}_{d 2}^{*} , {I}_{q 2}^{*} ) ,$$

a second inverter to apply a second output voltage to the second winding set and thereby causing a second output current to be generated in the second winding set in accordance with the second final current command

$$( {I}_{d 2}^{*} , {I}_{q 2}^{*} ) .$$

In another embodiment of the invention, a system for controlling a dual wound synchronous machine (DWSM) having a first winding set and a second winding set is provided. The system includes: a first inverter configured to selectively conduct current from a first DC voltage source having a first DC supply voltage, and to thereby apply a first output voltage to the first winding set of the DWSM; a second inverter configured to selectively conduct current from a second DC voltage source having a second DC supply voltage, and to thereby apply a second output voltage to the second winding set of the DWSM; and a controller. The controller is configured to: determine a positive virtual lower voltage limit (V_{pL}) based on the first DC supply voltage and the second DC supply voltage; determine, based on the positive virtual lower voltage limit (V_{pL}), a maximum torque for symmetric operation (T_{epkLP}, T_{epkLN});
determine, based on the maximum torque for symmetric operation (T_{epkLP}, T_{epkLN}), a requirement for asymmetric currents to operate the DWSM in accordance with a torque command

$$( {T}_{e}^{*} ) ;$$

determine, based on the positive virtual lower voltage limit (V_{pL}), and in response to the requirement for asymmetric currents, a set of final asymmetric motor current commands; determine a first final current command

$$( {I}_{d 1}^{*} , {I}_{q 1}^{*} )$$

and a second final current command

$$( {I}_{d 2}^{*} , {I}_{q 2}^{*} )$$

by applying a mathematical transformation to the set of final asymmetric motor current commands; command, based on the first final current command

$$( {I}_{d 1}^{*} , {I}_{q 1}^{*} ) ,$$

the first inverter to apply the first output voltage to the first winding set and thereby causing a first output current to be generated in the first winding set in accordance with the first final current command

$$( {I}_{d 1}^{*} , {I}_{q 1}^{*} ) ;$$

and command, based on the second final current command

$$( {I}_{d 2}^{*} , {I}_{q 2}^{*} ) ,$$

the second inverter to apply the second output voltage to the second winding set and thereby causing a second output current to be generated in the second winding set in accordance with the second final current command

$$( {I}_{d 2}^{*} , {I}_{q 2}^{*} ) .$$

These and other advantages and features will become more apparent from the following description taken in conjunction with the drawings.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic diagram of an electric power steering system according to the principles of the present disclosure.

FIG. 2 is a schematic diagram of a motor drive system according to the principles of the present disclosure.

FIG. 3 is a block diagram representation of a mathematical model of a dual wound permanent magnet synchronous machine in the synchronous reference frame according to the principles of the present disclosure.

FIG. 4 is a block diagram representation of mathematical transformations for decoupling two half-motors of a dual wound permanent magnet synchronous motor according to the principles of the present disclosure.

FIG. 5 is a block diagram showing a mathematical model showing two virtual motors of a dual wound permanent magnet synchronous motor resulting from the application of a decoupling transformation according to the principles of the present disclosure.

FIG. 6 is a block diagram showing a dual wound synchronous machine (DWSM) motor control system, according to the principles of the present disclosure.

FIG. 7 shows a graph of torque as a function of speed and showing various control regimes, according to the principles of the present disclosure.

FIG. 8 shows a graph of torque as a function of speed for a DWSM with different supply voltages and a 6 Nm torque command, using both a conventional control technique and a control technique according to the principles of the present disclosure.

FIG. 9 shows a graph of torque as a function of speed for a DWSM with different supply voltages and a 10 Nm torque command, using both a conventional control technique and a control technique according to the principles of the present disclosure.

FIGS. 10A-10D show a flow diagram illustrating a method for controlling a dual wound electric motor, according to the principles of the present disclosure.

### DETAILED DESCRIPTION

Referring now to the figures, where the present disclosure will be described with reference to specific embodiments, without limiting the same, it is to be understood that the disclosed embodiments are merely illustrative of the present disclosure that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

As used herein the terms module and sub-module refer to one or more processing circuits such as an application specific integrated circuit (ASIC), an electronic circuit, a processor (shared, dedicated, or group) and memory that executes one or more software or firmware programs, a combinational logic circuit, and/or other suitable components that provide the described functionality. As can be appreciated, the sub-modules described below can be combined and/or further partitioned.

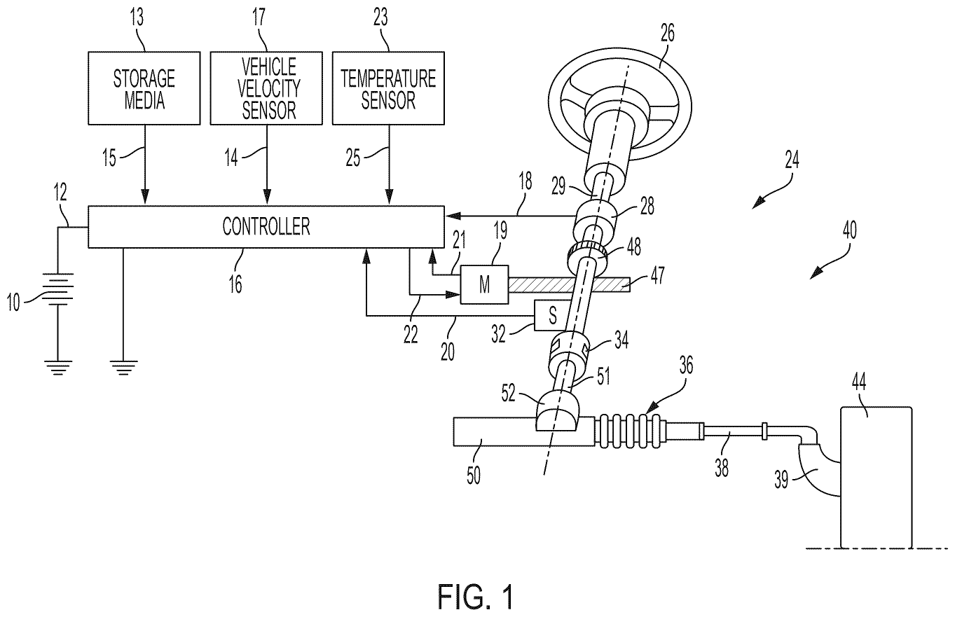

FIG. 1 is a schematic diagram of an electric power steering system (EPS) 40 suitable for implementation of the disclosed techniques. The EPS includes a steering mechanism 36, which includes a rack-and-pinion type mechanism having a toothed rack (not shown) within housing 50 and a pinion gear (also not shown) located under gear housing 52. As the operator input, hereinafter denoted as a steering wheel 26 (e.g. a handwheel and the like), is turned, the upper steering shaft 29 turns and the lower steering shaft 51, connected to the upper steering shaft 29 through universal joint 34, turns the pinion gear. Rotation of the pinion gear moves the rack, which moves tie rods 38 (only one shown) in turn moving the steering knuckles 39 (only one shown), which turn a steerable wheel(s) 44 (only one shown).

Electric power steering assist is provided through the steering motion control system generally designated by reference numeral 24 and includes the controller 16 and an electric machine, which could be a permanent magnet synchronous motor, and is hereinafter denoted as motor 19. The controller 16 is powered by the vehicle power supply 10 through supply conductors 12. The controller 16 receives a vehicle speed signal 14 representative of the vehicle velocity from a vehicle velocity sensor 17. Steering angle is measured through position sensor 32, which may be an optical encoding type sensor, variable resistance type sensor, or any other suitable type of position sensor, and supplies to the controller 16 a position signal 20. Motor velocity may be measured with a tachometer, or any other device, and transmitted to controller 16 as a velocity signal 21. A motor velocity denoted ωₘ may be measured, calculated or a combination thereof. For example, the motor velocity ωₘ may be calculated as the change of the motor position as measured by a position sensor 32 over a prescribed time interval. For example, motor speed ωₘ may be determined as the derivative of the motor position θₘ with respect to time. It will be appreciated that there are numerous well-known methodologies for performing the function of a derivative.

As the steering wheel 26 is turned, torque sensor 28 senses the torque applied to the steering wheel 26 by the vehicle operator. The torque sensor 28 may include a torsion bar (not shown) and a variable resistive-type sensor (also not shown), which outputs a torque signal 18 to controller 16 in relation to the amount of twist on the torsion bar. Although this is one type of torque sensor, any other suitable torque-sensing device used with known signal processing techniques will suffice. In response to the various inputs, the controller sends a command 22 to the motor 19, which supplies torque assist to the steering system through worm 47 and worm gear 48, providing torque assist to the vehicle steering.

It should be noted that although the disclosed embodiments are described by way of reference to motor control for electric steering applications, it will be appreciated that such references are illustrative only and the disclosed embodiments may be applied to any motor control application employing an electric motor, e.g., steering, valve control, and the like. Moreover, the references and descriptions herein may apply to many forms of parameter sensors, including, but not limited to torque, position, speed and the like. It should also be noted that reference herein to electric machines including, but not limited to, motors, hereafter, for brevity and simplicity, reference will be made to motors only without limitation.

In the steering motion control system 24 as depicted, the controller 16 utilizes the torque, position, and speed, and like, to compute a command(s) to deliver the required output power. Controller 16 is disposed in communication with the various systems and sensors of the motor control system. Controller 16 receives signals from each of the system sensors, quantifies the received information, and provides an output command signal(s) in response thereto, in this instance, for example, to the motor 19. Controller 16 is configured to develop the corresponding voltage(s) out of inverter (not shown), which may optionally be incorporated with controller 16 and will be referred to herein as controller 16, such that, when applied to the motor 19, the desired torque or position is generated. In one or more examples, the controller 16 operates in a feedback control mode, as a current regulator, to generate the command 22. Alternatively, in one or more examples, the controller 16 operates in a feedforward control mode to generate the command 22. Because these voltages are related to the position and speed of the motor 19 and the desired torque, the position and/or speed of the rotor and the torque applied by an operator are determined. A position encoder is connected to the steering shaft 51 to detect the angular position θ. The encoder may sense the rotary position based on optical detection, magnetic field variations, or other methodologies. Typical position sensors include potentiometers, resolvers, synchros, encoders, and the like, as well as combinations comprising at least one of the forgoing. The position encoder outputs a position signal 20 indicating the angular position of the steering shaft 51 and thereby, that of the motor 19.

Desired torque may be determined by one or more torque sensors 28, which transmit the torque signals 18 indicative of an applied torque. Such a torque sensor 28 and the torque signals 18 therefrom, as may be responsive to a compliant torsion bar, spring, or similar apparatus (not shown) configured to provide a response indicative of the torque applied.

In one or more examples, a temperature sensor 23 is located at the motor 19. Preferably, the temperature sensor 23 is configured to directly measure the temperature of the sensing portion of the motor 19. The temperature sensor 23 transmits a temperature signal 25 to the controller 16 to facilitate the processing prescribed herein and compensation. Typical temperature sensors include thermocouples, thermistors, thermostats, and the like, as well as combinations comprising at least one of the foregoing sensors, which when appropriately placed provide a calibratable signal proportional to the particular temperature.

The position signal 20, velocity signal 21, and torque signals 18 among others, are applied to the controller 16. The controller 16 processes all input signals to generate values corresponding to each of the signals resulting in a rotor position value, a motor speed value, and a torque value being available for the processing in the algorithms as prescribed herein. Measurement signals, such as the above mentioned are also commonly linearized, compensated, and filtered as desired to enhance the characteristics or eliminate undesirable characteristics of the acquired signal. For example, the signals may be linearized to improve processing speed, or to address a large dynamic range of the signal. In addition, frequency or time based compensation and filtering may be employed to eliminate noise or avoid undesirable spectral characteristics.

In order to perform the prescribed functions and desired processing, as well as the computations therefore (e.g., the identification of motor parameters, control algorithm(s), and the like), controller 16 may include, but not be limited to, a processor(s), computer(s), DSP(s), memory, storage, register(s), timing, interrupt(s), communication interface(s), and input/output signal interfaces, and the like, as well as combinations comprising at least one of the foregoing. For example, controller 16 may include input signal processing and filtering to enable accurate sampling and conversion or acquisitions of such signals from communications interfaces.

As used herein, variables with a tilde (~) above the variable symbol represent an approximation or estimation, which may be determined by a mathematical calculation, a lookup table, etc. Variables with a bar above the variable symbol represent a vector quantity. Variables with a superscript star (*) represent commands or desired set point values.

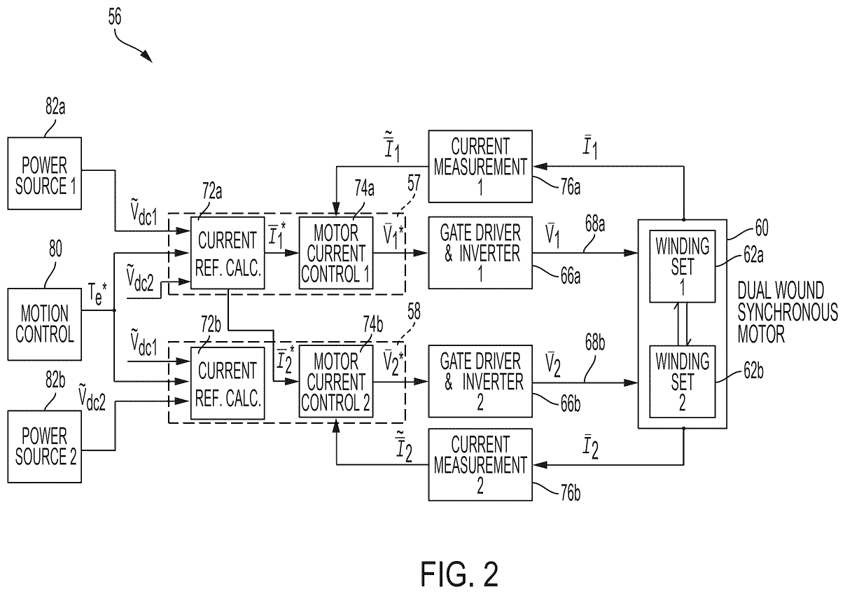

FIG. 2 illustrates a motor drive system 56, which includes a dual wound motor 60 having a first winding set 62a and a second winding set 62b that is electrically isolated from the first winding set 62a. The dual wound motor 60 may be used as the motor 19 in the steering motor drive system 24. However, the dual wound motor 60 of the present disclosure may be used in other applications.

The motor drive system 56 is configured to supply power to the winding sets 62a, 62b for operating the dual wound motor 60 to generate an output torque in accordance with a motor torque command

$${T}_{e}^{*} .$$

The motor drive system 56 includes a first electronic control unit (ECU) 57 and a second ECU 58 that is independent of the first ECU 57. For redundancy, each of the ECUs 57, 58 may control power supply to a corresponding one of the winding sets 62a, 62b. The motor torque command

$${T}_{e}^{*}$$

may be generated by a motion controller 80, such as a controller of an electric power steering (EPS) system.

The motor drive system 56 includes a first power converter 66a configured to apply a first output voltage V̅₁ to the first winding set 62a via a first motor lead 68a and based on a first voltage command

$${\overline{V}}_{1}^{*} .$$

The motor drive system 56 also includes a second power converter 66b that is configured to apply a second output voltage V̅₂ to the second winding set 62b via a second motor lead 68a and based on a second voltage command

$${\overline{V}}_{2}^{*} .$$

Each of the output voltages \hat{V}₁, \hat{V}₂ may be 3-phase voltages where the winding sets 62a, 62b each have 3-phase configurations. However, the output voltages \hat{V}₁, \hat{V}₂ may represent a different number of phases to match a different configuration of the winding sets 62a, 62b.

The motor drive system 56 also includes two separate and independent DC voltage sources 82a, 82b. The first DC voltage source 82a may supply the first DC supply voltage \tilde{V}_{dc1} for operating the first power converter 66a, and the second DC voltage source 82b may supply the second DC supply voltage \tilde{V}_{dc2} for operating the second power converter 66b. Each of the power converters 66a, 66b may selectively and rapidly switch current from a corresponding one of the DC voltage sources 82a, 82b in order to supply an alternating current (AC) output current to a corresponding winding set 62a, 62b of the DW-PMDC machine 60. The first and second DC supply voltages \tilde{V}_{dc1}, \tilde{V}_{dc2} may have similar or identical nominal design voltage values. However, in some situations, the first and second DC supply voltages \tilde{V}_{dc1}, \tilde{V}_{dc2} may be different. For example, if one of the DC voltage sources 82a, 82b is damaged or degraded, the corresponding DC supply voltage \tilde{V}_{dc1}, \tilde{V}_{dc2} may be reduced. The ECUs 57, 58 may each monitor the first DC supply voltage \tilde{V}_{dc1} and the second DC supply voltage \tilde{V}_{dc2}.

The first ECU 57 includes a first current reference calculator 72a that is configured to compute generate a first reference current

$${\overline{I}}_{1}^{*}$$

for the first winding set 62a and a second reference current

$${\overline{I}}_{2}^{*}$$

for the second winding set 62b, each based on: the motor torque command

$${T}_{e}^{*} ,$$

the first DC supply voltage \tilde{V}_{dc1}, and the second DC supply voltage \tilde{V}_{dc2}. The first ECU 57 may transmit the second reference current

$${\overline{I}}_{2}^{*}$$

to the second ECU 58 via inter-microcontroller (IMC) communications. However, the first ECU 57 may send the second reference current

$${\overline{I}}_{2}^{*}$$

to the second ECU 58 by other means, such as a direct analog I/O signal or on a different communications network. This arrangement, with the first ECU 57 generating both the first reference current

$${\overline{I}}_{1}^{*} ,$$

and the second reference current

$${\overline{I}}_{2}^{*} .$$

may be called a primary dependent architecture.

In some embodiments, the first current reference calculator 72a may be configured to sense the first DC supply voltage \tilde{V}_{dc1} of the first DC voltage source 82a and/or the second DC supply voltage \tilde{V}_{dc2} of the second DC voltage source 82b.

The second ECU 58 includes a second current reference calculator 72b that is configured to generate, at least, the second reference current

$${\overline{I}}_{2}^{*}$$

for the second winding set 62b based on the motor torque command

$${T}_{e}^{*}$$

and the second DC supply voltage \tilde{V}_{dc2}. For simplicity of the disclosure, FIG. 2 only shows the reference currents

$${\overline{I}}_{1}^{*} , {\overline{I}}_{2}^{*}$$

from the first current reference calculator 72a, which may be used when the first ECU 57 is a primary ECU, and the second ECU 58 is a dependent ECU that receives the second reference current command

$${\overline{I}}_{2}^{*}$$

from the primary ECU. FIG. 2 does not show the reference currents

$${\overline{I}}_{1}^{*} , {\overline{I}}_{2}^{*} .$$

from the second current reference calculator 72b, which may be used only in case the second ECU 58 is a primary ECU. Thus, either of the first ECU 57 or the second ECU 58 may be used as the primary ECU to generate the reference currents

$${\overline{I}}_{1}^{*} , {\overline{I}}_{2}^{*} .$$

Accordingly, each of the first current reference calculator 72a of the first ECU 57 and the second current reference calculator 72b of the second ECU 58 may have a similar or identical configuration and which may generate both of the first and second reference currents

$${\overline{I}}_{1}^{*} , {\overline{I}}_{2}^{*} .$$

The second current reference calculator 72b of the second ECU 58 may be similar or identical to the first current reference calculator 72a of the first ECU 57. In some embodiments, the second current reference calculator 72b may also generate the first reference current

$${\overline{I}}_{1}^{*}$$

for the first winding set 62a. For example, the second current reference calculator 72b may be configured to compute the first reference current

$${\overline{I}}_{1}^{*}$$

and the second reference current

$${\overline{I}}_{2}^{*} ,$$

each based on: the motor torque command

$${T}_{e}^{*} ,$$

the first DC supply voltage \tilde{V}_{dc1}, and the second DC supply voltage \tilde{V}_{dc2}. The second ECU 58 may transmit the first reference current

$${\overline{I}}_{1}^{*}$$

to the first ECU 57 via inter-microcontroller (IMC) communications. However, the second ECU 58 may send the first reference current

$${\overline{I}}_{1}^{*}$$

to the first ECU 57 by other means, such as a direct analog I/O signal or on a different communications network.

The first ECU 57 also includes a first motor current controller 74a that is configured to command operation of the first power converter 66a. The first motor current controller 74a may compute the first voltage command

$${\overline{V}}_{1}^{*}$$

based on the first reference current

$${\overline{I}}_{1}^{*}$$

and based on a first measured current signal \tilde{Ī}₁ representing actual current in the first winding set 62a. The first voltage command

$${\overline{V}}_{1}^{*}$$

may include d-axis and q-axis constituent parts,

$${V}_{d 1}^{*} , {V}_{q 1}^{*} ,$$

respectively.

The second ECU 58 also includes a second motor current controller 74b that is configured to command operation of the second power converter 66b. The second motor current controller 74b may compute the second voltage command

$${\overline{V}}_{2}^{*}$$

based on the second reference current

$${\overline{I}}_{2}^{*}$$

and based on a second measured current signal \tilde{Ī}₂ representing actual current in the second winding set 62b. The second voltage command

$${\overline{V}}_{2}^{*}$$

may include d-axis and q-axis constituent parts,

$${V}_{d 2}^{*} , {V}_{q 2}^{*} ,$$

respectively.

Each of the first and second voltage commands

$${\overline{V}}_{1}^{*} , {\overline{V}}_{2}^{*}$$

are supplied to the corresponding one of the power converters 66a, 66b, thereby allowing independent voltage control of the two winding sets 62a, 62b. Alternatively, each of the motor current controllers 74a, 74b may send one or more different control signals for controlling operation of the corresponding power converter 66a, 66b, such as duty cycle signals for switches of the corresponding power converter 66a, 66b or a commanded modulation index mi and phase advance angle δ.

The motor drive system 56 includes a first current sensor 76a that is configured to measure current in the first winding set 62a and to supply the first measured current signal \tilde{Ī}₁ to the first motor current controller 74a. The motor drive system 56 also includes a second current sensor 76b that is configured to measure current in the second winding set 62b and to supply the second measured current signal \tilde{Ī}₂ to the second motor current controller 74b.

Control algorithm development for DW-PMSMs previously has assumed negligible inductive coupling exists between the two half-motors. While the idea that such coupling may exist has been conceived, sufficient analytical or mathematical models capturing the effect have not been derived or presented. As a result, conventional control designs do not consider this coupling, and there is always inherently some current induction between the two sides of the DW motor. This document presents a general mathematical model of DW-PMSMs in the synchronous or dq reference frame which is valid for non-salient as well as salient pole configurations. A simplified model that is applicable to non-salient pole machines is also provided.

The general mathematical model of DW-PMSMs is shown in equation (1), below.

$$[ \begin{matrix}{V}_{d 1} \\ {V}_{q 1} \\ {V}_{d 2} \\ {V}_{q 2}\end{matrix} ] = [ \begin{matrix}R + {L}_{d} s & {ω}_{e} {L}_{q} & {M}_{d} s & {ω}_{e} {M}_{q} \\ - {ω}_{e} {L}_{d} & R + {L}_{q} s & - {ω}_{e} {M}_{d} & {M}_{q} s \\ {M}_{d} s & {ω}_{e} {M}_{q} & R + {L}_{d} s & {ω}_{e} {L}_{q} \\ - {ω}_{e} {M}_{d} & {M}_{q} s & - {ω}_{e} {L}_{d} & R + {L}_{q} s\end{matrix} ] [ \begin{matrix}{I}_{d 1} \\ {I}_{q 1} \\ {I}_{d 2} \\ {I}_{q 2}\end{matrix} ] + {ω}_{e} [ \begin{matrix}0 \\ {λ}_{m} \\ 0 \\ {λ}_{m}\end{matrix} ] \qquad ( 1 )$$

In this model, under the assumption of identical half machines, the two sides, or half-motors are referred to using subscripts 1 and 2, V_{d} and V_{q} are the d-axis and q-axis motor voltages, respectively. I_{d} and I_{q} are the d-axis and q-axis motor currents, respectively. R is the phase resistance, L_{d} and L_{q} are the d-axis and q-axis inductances, respectively of each half-motor. M_{d} and M_{q} are the inductance terms that represent coupling between the two half-motors, ωₑ is the electrical motor velocity, and λₘ is the permanent magnet (PM) flux linkage. Note that the electrical motor velocity is also referred to as the synchronous frequency of the machine and is related to the mechanical motor velocity ωₘ as follows:

$${ω}_{e} = p {ω}_{m} \qquad ( 2 )$$

Additionally, a motor constant Kₑ (Volt/rad/s) is related to the PM flux linkage λₘ by the number of poles Nₚ, as set forth in equation (3), below:

$${λ}_{m} = \frac{2}{{N}_{p}} {K}_{e} \qquad ( 3 )$$

The electromagnetic torque Tₑ may be determined by equation (4), below:

$${T}_{e} = \frac{3}{2} \frac{{N}_{p}}{2} ( ( {λ}_{m} ( {i}_{q 1} + {i}_{q 2} ) ) + ( {L}_{q} - {L}_{d} ) ( {i}_{d 1} {i}_{q 1} + {i}_{d 2} {i}_{q 2} ) + ( {M}_{q} - {M}_{d} ) ( {i}_{d 1} {i}_{q 1} ) \qquad ( 4 )$$

An alternative model of dual wound PMSM machines after applying a symmetric asymmetric transformation, can be written as set forth in equation (5), below:

$$[ \begin{matrix}{\overline{V}}_{d 1} \\ {\overline{V}}_{q 1} \\ {\overline{V}}_{d 2} \\ {\overline{V}}_{q 2}\end{matrix} ] = [ \begin{matrix}R + {L}_{d} s & {ω}_{e} {L}_{q} & 0 & 0 \\ - {ω}_{e} {L}_{d} & R + {L}_{q} s & 0 & 0 \\ 0 & 0 & R + {L}_{d} s & {ω}_{e} {L}_{q} \\ 0 & 0 & - {ω}_{e} {L}_{d} & R + {L}_{q} s\end{matrix} ] [ \begin{matrix}{\overline{I}}_{d 1} \\ {\overline{I}}_{q 1} \\ {\overline{I}}_{d 2} \\ {\overline{I}}_{q 2}\end{matrix} ] + [ \begin{matrix}0 \\ 2 {ω}_{e} {λ}_{m} \\ 0 \\ 0\end{matrix} ] \qquad ( 5 )$$

The electromagnetic torque Tₑ may be represented by equations (6)-(7), below:

$${T}_{e} = 1.5 pp [ ( {λ}_{m} {I}_{qp} ) + ( 0.5 * ( {L}_{qp} - {L}_{dp} ) {I}_{dp} {I}_{qp} ) + ( 0.5 * ( {L}_{qn} - {L}_{dn} ) * {I}_{dn} {I}_{qn} ) ] \qquad ( 6 )$$

$${T}_{e} = {T}_{eP} + {T}_{eN} \qquad ( 7 )$$

where pp represents the number of pole pairs, and subscripts p and n represent parameters related to positive and negative virtual decoupled machines, respectively, as set forth in equation set (8), below:

$$\begin{matrix}{L}_{dp} = {L}_{d} + {M}_{d} \\ {L}_{qp} = {L}_{q} + {M}_{q} \\ {L}_{dn} = {L}_{d} - {M}_{d} \\ {L}_{qn} = {L}_{q} - {M}_{q} \\ {V}_{dp} = {V}_{d 1} + {V}_{d 2} \\ {V}_{qp} = {V}_{q 1} + {V}_{q 2} \\ {V}_{dn} = {V}_{d 1} - {V}_{d 2} \\ {V}_{qn} = {V}_{q 1} - {V}_{q 2}\end{matrix} \qquad ( 8 )$$

where L_{dp} and L_{qp} represent d-axis and q-axis inductances of the positive virtual decoupled machine, respectively, L_{dn} and L_{qn} represent d-axis and q-axis inductances of the negative virtual decoupled machine, respectively, V_{dp} and V_{qp} represent d-axis and q-axis voltages of the positive virtual decoupled machine, respectively, and where V_{dn} and V_{qn} represent d-axis and q-axis voltages of the negative virtual decoupled machine, respectively. Where L_{d} and L_{q} represent d-axis and q-axis inductances, respectively of one of the winding sets 62a, 62b of the dual wound motor 60, and M_{d} and M_{q} represent d-axis and q-axis mutual inductances, respectively, between the winding sets 62a, 62b of the dual wound motor 60. Where V_{d1} and V_{q1} represent d-axis and q-axis voltages, respectively, of the first winding set 62a, and V_{d2} and V_{q2} represent d-axis and q-axis voltages, respectively, of the second winding set 62b.

Under steady state, the DW-PMSMs may be descried by equation set (9), below:

$$\begin{matrix}{\overline{V}}_{dp} = R {\overline{I}}_{dp} + {ω}_{e} {L}_{qp} {\overline{I}}_{qp} \\ {\overline{V}}_{qp} = - {ω}_{e} {L}_{dp} {\overline{I}}_{dp} + R {\overline{I}}_{qp} + 2 {ω}_{e} {λ}_{m}\end{matrix} \qquad ( 9 )$$

$$\begin{matrix}{\overline{V}}_{mp} = \sqrt{{\overline{V}}_{dp}^{2} + {\overline{V}}_{qp}^{2}} \\ {\overline{V}}_{dn} = R {\overline{I}}_{dn} + {ω}_{e} {L}_{qp} {\overline{I}}_{qn} \\ {\overline{V}}_{qn} = - {ω}_{e} {L}_{dn} {\overline{I}}_{dn} + R {\overline{I}}_{qn} \\ {\overline{V}}_{mn} = \sqrt{{\overline{V}}_{dn}^{2} + {\overline{V}}_{qn}^{2}}\end{matrix}$$

where V̅ₘₚ represents a root mean square (RMS) total voltage of a positive virtual decoupled machine, and V̅ₘₙ represents a root mean square (RMS) total voltage of the negative virtual decoupled machine.

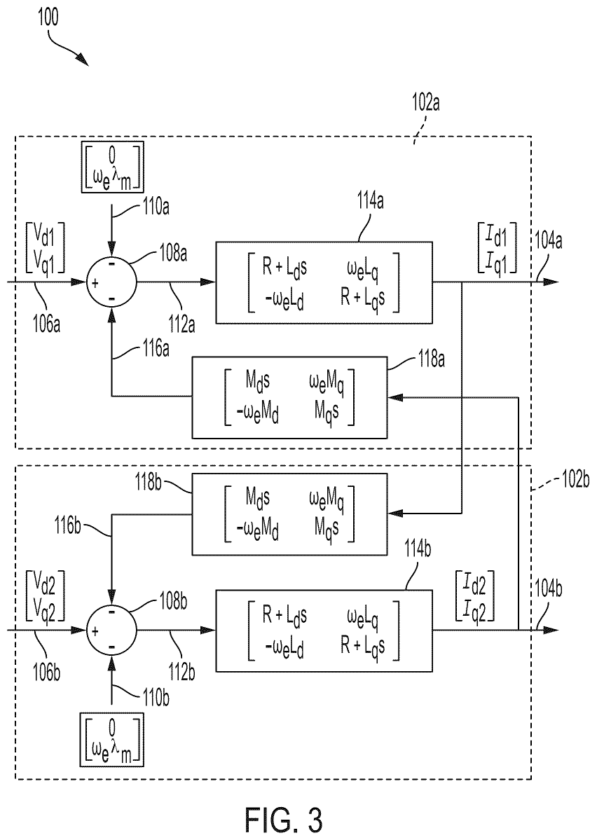

The two diagonal square matrices of equation (1) represent mathematical models of the individual windings sets, which is identical to that of a conventional single winding PMSM, while the off-diagonal matrices illustrate the coupling between the two sets of windings. A block diagram 100 representing this generalized mathematical model for a dual wound motor 60 is shown in FIG. 3.

Specifically, the block diagram 100 of FIG. 3 includes a first winding model 102a, and a second winding model 102b, with each of the winding models 102a, 102b representing operation of a corresponding one of the winding sets 62a, 62b of the dual wound motor 60. The first winding model 102a produces a first output signal 104a representing the first d-axis and q-axis currents I_{d1}, I_{q1} generated by the first winding set 62a in response to a given first winding voltage signal 106a. Likewise, the second winding model 102b produces a second output signal 104b representing the second d-axis and q-axis currents I_{d2}, I_{q2} generated by the second winding set 62b in response to a given second winding voltage signal 106b.

The first winding model 102a receives, as the first winding voltage signal 106a, a matrix with values for the first d-axis voltage V_{d1} and the first q-axis voltage V_{q1} applied to the first winding set 62a. This first winding voltage signal 106a is supplied to a first addition block 108a, which subtracts a first back-EMF (BEMF) signal 110a and produces a first composite signal 112a. The first composite signal 112a may represent a total sum of the voltages acting on the first winding set 62a. The first BEMF signal 110a represents BEMF generated by the first winding set 62a. The first composite signal 112a is supplied to a first transformation block 114a which generates the first output signal 104a based on the first composite signal 112a.

The second winding model 102b receives, as the second winding voltage signal 106b, a matrix with values for the second d-axis voltage V_{d2} and the second q-axis voltage V_{q2} applied to the second winding set 62b. This second winding voltage signal 106b is supplied to a second addition block 108b, which subtracts a second BEMF signal 110b and produces a second composite signal 112b. The second composite signal 112b may represent a total sum of the voltages acting on the second winding set 62b. The second BEMF signal 110b represents BEMF generated by the second winding set 62b. The second composite signal 112b is supplied to a second transformation block 114b which generates the second output signal 104b based on the second composite signal 112b.

The first winding model 102a also includes a first coupling transform block 118a that produces a first coupling voltage signal 116a based on the second output signal 104b. The first coupling voltage signal 116a represents effects on the first winding set 62a due to current in the second winding set 62b. The first coupling voltage signal 116a is supplied to the first addition block 108a, which reduces each component of the first composite signal 112a by a corresponding component value of the first coupling voltage signal 116a.

Likewise, the second winding model 102b also includes a second coupling transform block 118b that produces a second coupling voltage signal 116b based on the first output signal 104a. The second coupling voltage signal 116b represents effects on the second winding set 62b due to current in the first winding set 62a. The second coupling voltage signal 116b is supplied to the second addition block 108b, which reduces each component of the second composite signal 112b by a corresponding component value of the second coupling voltage signal 116b.

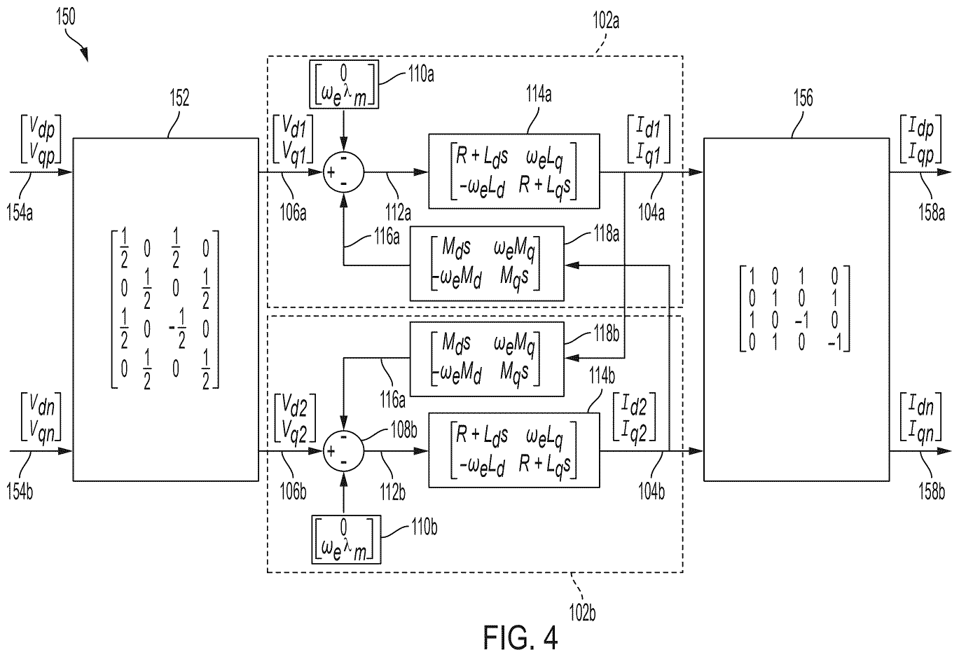

Through mathematical manipulations shown in equations (10)-(12), below, the winding models 102a, 102b may be transformed, from a controls perspective, into two virtual-machines that are decoupled, as illustrated in FIG. 4.

$${X}_{pn} = [ {R}_{f} ] {X}_{12} \qquad ( 10 )$$

$${X}_{12} = [ {R}_{b} ] {X}_{pn} \qquad ( 11 )$$

$${R}_{b} = {R}_{f}^{- 1} \qquad ( 12 )$$

where Xₚₙ represents voltages or currents supplied to the positive and negative half-machines, X₁₂ represents a corresponding set of voltages or currents supplied to the winding sets 62a, 62b of the dual wound motor 60, R_{f} represents a forward-direction transform and R_{b} represents a backward-direction transform. Further, note that equation (12) shows that the backward-direction transform is the inverse of the forward-direction transform. In some embodiments, the forward-direction transform R_{f} may take the form of the output transformation block 156. In some embodiments, the backward-direction transform R_{b} may take the form of the input transformation block 152.

FIG. 4 shows a block diagram 150 of a dual wound PMSM model with these mathematical transformations applied on the voltage inputs and current outputs. Specifically, the block diagram 150 includes an input transformation block 152 that generates the first winding voltage signal 106a and the second winding voltage signal 106b based on a positive virtual motor voltage signal 154a and a negative virtual motor voltage signal 154b. The positive virtual motor voltage signal 154a takes the form of 2×1 matrix with values for a d-axis voltage V_{dp} and a q-axis voltage V_{qp} supplied to the positive virtual motor. Similarly, the negative virtual motor voltage signal 154b takes the form of 2×1 matrix with values for a d-axis voltage V_{dn} and a q-axis voltage V_{qn} supplied to the negative virtual motor.

The block diagram 150 also includes an output transformation block 156 that generates a positive virtual motor current signal 158a and a negative virtual motor current signal 158b based on the first output signal 104a from the first winding model 102a and based on the second output signal 104b from the second winding model 102b. The positive virtual motor current signal 158a takes the form of 2×1 matrix with values for a d-axis current I_{dp} and a q-axis current I_{qp}. Similarly, the negative virtual motor current signal 158b takes the form of 2×1 matrix with values for a d-axis current I_{dn} and a q-axis current I_{qn}.

With the transformations performed, the resultant machine model shown in equation (13) is obtained as follows:

$$[ \begin{matrix}{V}_{dp} \\ {V}_{qp} \\ {V}_{dn} \\ {V}_{qn}\end{matrix} ] = [ \begin{matrix}R + ( {L}_{d} + {M}_{d} ) s & {ω}_{e} ( {L}_{q} + {M}_{q} ) & 0 & 0 \\ - {ω}_{e} ( {L}_{d} + {M}_{d} ) & R + ( {L}_{q} + {M}_{q} ) s & 0 & 0 \\ 0 & 0 & R + ( {L}_{d} + {M}_{d} ) s & {ω}_{e} ( {L}_{q} + {M}_{q} ) \\ 0 & 0 & - {ω}_{e} ( {L}_{d} + {M}_{d} ) & R + ( {L}_{q} + {M}_{q} ) s\end{matrix} ] [ \begin{matrix}{I}_{dp} \\ {I}_{qp} \\ {I}_{dn} \\ {I}_{qn}\end{matrix} ] + [ \begin{matrix}0 \\ 2 {λ}_{m} \\ 0 \\ 0\end{matrix} ] \qquad ( 13 )$$

The electromagnetic torque Tₑ obtained as a result of the mathematical transformations may be expressed as shown in equation (14) as follows:

$${T}_{e} = 1.5 pp [ ( {λ}_{m} {I}_{qp} ) + ( 0.5 * ( {L}_{qp} - {L}_{dp} ) {I}_{dp} {I}_{qp} ) + ( 0.5 * ( {L}_{qn} - {L}_{dn} ) * {I}_{dn} {I}_{qn} ) ] \qquad ( 14 )$$

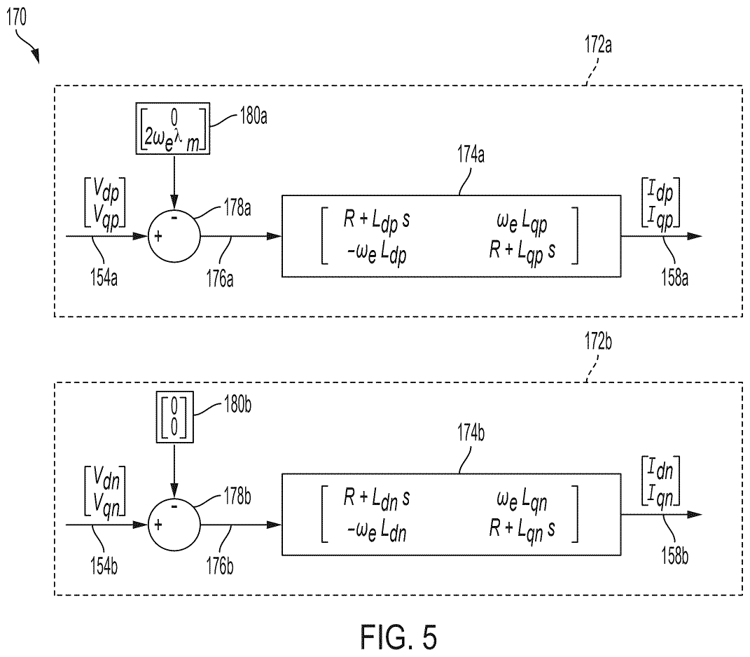

A block diagram representation of the decoupled model 170 is shown in FIG. 5. This decoupled model 170 may also be referred to as virtual model of dual wound PMSMs, as it illustrates two separate mathematical models that are independent of one another, and thus consists of a positive virtual motor and a negative virtual motor model that are decoupled from one another. Note that once the appropriate transformations related to the transformation matrices R_{f}, R_{b} would need to be applied at the interfaces of the control algorithm blocks (not shown), the control algorithm design may be performed with the assumption that the “effective” motor (plant) from the standpoint of the controller is the decoupled model 170 of the dual wound motor 60 including positive and negative virtual motor windings 172a, 172b that are decoupled from one-another. Therefore, the decoupled model 170 includes a positive virtual motor winding 172a and a negative virtual motor winding 172b. The positive virtual motor winding 172a may also be called a positive virtual motor, and the negative virtual motor winding 172b may also be called a negative virtual motor. The positive and negative virtual motor windings 172a, 172b may represent the positive and negative virtual decoupled machines, respectively.

The positive virtual motor winding 172a may represent symmetric operation of the winding sets 62a, 62b of the dual wound motor 60. The negative virtual motor winding 172b may represent asymmetric operation of the winding sets 62a, 62b of the dual wound motor 60. The negative virtual motor voltage signal 154b and the negative virtual motor current signal 158b may each be zero during symmetric operation, when the first winding voltage signal 106a is equal to the second winding voltage signal 106b and the first output signal 104a representing the first d-axis and q-axis currents I_{d1}, I_{q1} is equal to the second output signal 104b representing the second d-axis and q-axis currents I_{d2}, I_{q2}.

The positive virtual motor winding 172a receives the positive virtual motor voltage signal 154a and produces the positive virtual motor current signal 158a. The positive virtual motor winding 172a includes a positive virtual motor transfer matrix 174a that describes its dynamic behavior. The net voltage 176a resulting from the input voltage overcoming the BEMF voltage 180a, which is represented as a difference operation performed by the subtraction module 178a, serves as the input to the positive virtual motor transfer matrix 174a which produces the positive virtual motor current signal 158a. Note that the positive virtual motor BEMF voltage signal 180a includes a term 2ωₑλₘ, which incorporates both the BEMF signals 110a, 110b of the first winding model 102a and the second winding model, 102b, respectively.

The negative virtual motor winding 172b receives the negative virtual motor voltage signal 154b and produces the negative virtual motor current signal 158b. The negative virtual motor winding 172b includes a negative virtual motor transfer matrix 174b that describes its dynamic behavior. The net voltage 176b resulting from the input voltage overcoming a voltage represented by a negative virtual motor BEMF voltage signal 180b, which is represented as a difference result of a subtraction module 178b, serves as the input to the negative virtual motor transfer matrix 174b which produces the negative virtual motor current signal 158b. Note that the negative virtual motor BEMF voltage signal 180b includes a zero matrix, due to the positive virtual motor BEMF voltage signal 180a incorporating both the BEMF signals 110a, 110b of the first winding models 102a and the second winding model 102b, respectively. In other words, and unlike the positive virtual motor winding 172a, the negative virtual motor winding 172b does not include any BEMF compensation.

With the transformations applied on the generalized model that results in the virtual motor windings 172a, 172b, the overall current regulation problem may be reduced to the regulation of the positive and negative virtual motor current signals 158a, 158b. The virtual motor windings 172a, 172b, each behave essentially the same as a typical single winding three-phase PMSM and thus, enhanced current regulation techniques may be employed for generating the corresponding virtual motor voltage signals 154a, 154b.

The mathematical model of the positive and negative virtual half-machines may be generalized and written in a compact form as equation (15), below:

$$[ \begin{matrix}{V}_{dx} \\ {V}_{qx}\end{matrix} ] = [ \begin{matrix}{L}_{dx} s + R & {ω}_{e} {L}_{qx} \\ - {ω}_{e} {L}_{dx} & {L}_{qx} s + R\end{matrix} ] [ \begin{matrix}{I}_{dx} \\ {I}_{qx}\end{matrix} ] + u [ \begin{matrix}0 \\ {ω}_{e} {λ}_{m}\end{matrix} ] \qquad ( 15 )$$

where x may be replaced by either p or n and thus represents the positive or negative virtual half-machine, while u is a scalar quantity equal to 2 or 0 for the first and second virtual half-machine, respectively.

The inductance terms for the two half machines may be expressed in terms of the self and coupling inductances of the dual wound motor 60 as shown in equations (16)-(19), as follows:

$${L}_{dp} = {L}_{d} + {M}_{d} \qquad ( 16 )$$

$${L}_{qp} = {L}_{q} + {M}_{q} \qquad ( 17 )$$

$${L}_{dn} = {L}_{d} - {M}_{d} \qquad ( 18 )$$

$${L}_{qn} = {L}_{q} - {M}_{q} \qquad ( 19 )$$

The motor drive system 56 may include a current command generator, a current regulator, and a power converter controller. The current command generator is configured to generate a current command based on the motor torque command

$${T}_{e}^{*} .$$

The current command generator may limit the torque produced based on machine capability and power management algorithms. The current regulator may perform closed loop or feedback current control techniques to control the amount of current generated by the DW-PMSMs. The power converter controller may convert d-axis and q-axis voltage commands from the current regulator into duty cycles that are then sent to the gate driver and inverter which in-turn apply the required voltages to the winding sets 62a, 62b of the dual wound motor 60.

The objective of the control algorithm is to optimize the torque output of a dual-wound Permanent Magnet Synchronous Motor (PMSM) under conditions of unequal voltage availability. Initially, the algorithm ensures the symmetric nature of currents in both Electronic Control Units (ECUs) until the required voltage is available for each ECU. Subsequently, it optimizes the current commands between the ECUs to maximize torque while minimizing asymmetry in the current commands.

To achieve this, the machine 60 is treated as a single entity, and a transformation is applied to analyze it in terms of the P-side (representing symmetric nature) and N-side (representing asymmetric nature). Upon completion of the algorithm, an inverse transformation is used to convert the P-side and N-side currents back to ECU 1 and ECU 2 currents. The detailed steps of the algorithm are outlined below.

BRIDGE VOLTAGE LIMIT DETERMINATION & ALLOCATION—Bridge voltage limits may be determined and power allocated for operation of each of the virtual machines 172a, 172b by first calculating maximum and minimum voltage limits for the virtual machines 172a, 172b based on the DC supply voltages V_{dc1}, V_{dc2} of the DC voltage sources 82a, 82b. A voltage threshold is also determined at which asymmetric control of the two winding sets 62a, 62b provides increased torque output.

The first step is to determine the limits of the virtual machine 172a, 172b, which may be essential to determine the peak torque capability for a positive virtual machine and negative virtual machine. V_{pU} and V_{pL} are the upper and lower limits of positive virtual machine 172a, respectively. Vₙ is the limit of negative virtual machine 172b. The limits of V_{pU}, V_{pL}, Vₙ are calculated as shown in equations (20)-(22), as follows:

$${V}_{pU} = {V}_{dc 1} + {V}_{dc 2} \qquad ( 20 )$$

$${V}_{pL} = 2 * min ( {V}_{dc 1} , {V}_{dc 2} ) \qquad ( 21 )$$

$${V}_{n} = {V}_{dc 1} - {V}_{dc 2} \qquad ( 22 )$$

where min(V_{dc1}, V_{dc2}) is a function that outputs a value of one of first and second DC supply voltages V_{dc1}, V_{dc2} and which has a lower value.

The system and method of the present disclosure may determine a positive virtual upper-voltage-limit-based maximum positive torque T_{epkUP} and a positive virtual upper-voltage-limit-based maximum negative torque T_{epkUN}, each based on the positive virtual upper voltage limit V_{pU}. The system and method of the present disclosure may also compute a positive virtual lower-voltage-based maximum positive torque T_{epkLP} and a positive virtual lower-voltage-based maximum negative torque T_{epkLN}, each based on the positive virtual lower voltage limit V_{pL}. The system and method of the present disclosure may also compute a positive virtual total peak torque T_{epkP} and a negative virtual total peak torque T_{epkN}, each based on the positive virtual upper voltage limit V_{pU} and the negative virtual voltage limit Vₙ.

The system and method of the present disclosure may determine applied voltages V̅_{dp}, V̅_{qp} of the positive virtual motor winding 172a at the positive virtual upper voltage limit V_{pU}, based on equations (23)-(26), below:

$${\overline{V}}_{dp} = R {\overline{I}}_{dp} + {ω}_{e} {L}_{qp} {\overline{I}}_{qp} \qquad ( 23 )$$

$${\overline{V}}_{qp} = - {ω}_{e} {L}_{dp} {\overline{I}}_{dp} + R {\overline{I}}_{qp} + 2 {ω}_{e} {λ}_{m} \qquad ( 24 )$$

$${\overline{V}}_{dp} = {\overline{V}}_{pU} sin {δ}_{p} \qquad ( 25 )$$

$${\overline{V}}_{qp} = {\overline{V}}_{pU} cos {δ}_{p} \qquad ( 26 )$$

where δₚ is the voltage angle of the positive virtual machine, and δₙ is the voltage angle of the negative virtual machine. motor winding 172b. The voltage angle of the positive virtual machine δₚ may be equal to the voltage angle of the negative virtual machine δₙ.

The system and method of the present disclosure may sweep across a range of values of the voltage angle δₚ and compute d-axis and q-axis currents I_{dpU} and I_{qpU} corresponding to the positive virtual upper voltage limit V_{pU}, in accordance with equations (27) and (28), below. The system and method of the present disclosure may use those currents I_{dpU} and I_{qpU} corresponding to the positive virtual upper voltage limit V_{pU}, to obtain a torque T_{ePU} corresponding to the positive virtual upper voltage limit V_{pU}, as set forth in equation (29), below.

$${I}_{qpU} = \frac{{V}_{pU} ( {ω}_{e} {L}_{dp} sin {δ}_{p} + R cos {δ}_{p} ) - 2 {K}_{e} {ω}_{m} R}{{R}^{2} + {ω}_{e}^{2} {L}_{qp}^{2} {L}_{dp}^{2}} \qquad ( 27 )$$

$${I}_{dpU} = \frac{{V}_{pU} ( - {ω}_{e} {L}_{qp} cos {δ}_{p} + R sin {δ}_{p} ) + 2 {K}_{e} {ω}_{m} {ω}_{e} {L}_{qp}}{{R}^{2} + {ω}_{e}^{2} {L}_{qp}^{2} {L}_{dp}^{2}} \qquad ( 28 )$$

$${T}_{ePU} = \frac{3}{2} pp [ ( {λ}_{m} {I}_{qpU} ) + ( 0.5 * ( {L}_{qp} - {L}_{dp} ) {I}_{dpU} {I}_{qpU} ) ] \qquad ( 29 )$$

The system and method of the present disclosure may then compute the positive virtual upper-voltage-limit-based maximum positive torque T_{epkUP} and the positive virtual upper-voltage-limit-based maximum negative torque T_{epkUN}, each based on the torque T_{ePU} corresponding to the positive virtual upper voltage limit V_{pU}, and in accordance with equations (30) and (31), below.

$${T}_{epkUP} = max ( {T}_{epU} ) \qquad ( 30 )$$

$${T}_{epkUN} = min ( {T}_{epU} ) \qquad ( 31 )$$

The system and method of the present disclosure may also sweep across a range of values of the positive virtual voltage angle voltage angle δₚ and compute d-axis and q-axis currents I_{dpL} and I_{qpL} corresponding to the positive virtual lower voltage limit V_{pL}, in accordance with equations (32) and (33), below. The system and method of the present disclosure may use those currents I_{dpL} and I_{qpL} corresponding to the positive virtual lower voltage limit V_{pL}, to obtain a torque T_{ePL} corresponding to the positive virtual lower voltage limit V_{pL}, as set forth in equation (34), below.

$${I}_{qpL} = \frac{{V}_{pL} ( {ω}_{e} {L}_{dp} sin {δ}_{p} + R cos {δ}_{p} ) - 2 {K}_{e} {ω}_{m} R}{{R}^{2} + {ω}_{e}^{2} {L}_{qp}^{2} {L}_{dp}^{2}} \qquad ( 32 )$$

$${I}_{dpL} = \frac{{V}_{pL} ( - {ω}_{e} {L}_{qp} cos {δ}_{p} + R sin {δ}_{p} ) + 2 {K}_{e} {ω}_{m} {ω}_{e} {L}_{qp}}{{R}^{2} + {ω}_{e}^{2} {L}_{q p}^{2} {L}_{d p}^{2}} \qquad ( 35 )$$

$${T}_{ePL} = \frac{3}{2} pp [ ( {λ}_{m} {I}_{qpL} ) + ( 0.5 * ( {L}_{qp} - {L}_{dp} ) {I}_{dpL} {I}_{qpL} ) ] \qquad ( 34 )$$

The system and method of the present disclosure may then compute the positive virtual lower-voltage-limit-based maximum positive torque T_{epkLP} and the positive virtual lower-voltage-limit-based maximum negative torque T_{epkLN}, each based on the torque T_{ePL} corresponding to the positive virtual lower voltage limit V_{pL}, and in accordance with equations (35) and (36), below.

$${T}_{epkLP} = max ( {T}_{epL} ) \qquad ( 35 )$$

$${T}_{epkLN} = min ( {T}_{epL} ) \qquad ( 36 )$$

The system and method of the present disclosure may also sweep across a range of values of a voltage angle δₙ and compute d-axis and q-axis currents I_{dn} and I_{qn} corresponding to the negative virtual voltage limit Vₙ, in accordance with equations (37) and (38), below. The system and method of the present disclosure may use those currents I_{dn} and I_{qn} corresponding to the negative virtual voltage limit Vₙ to obtain a torque T_{eN} corresponding to the negative virtual voltage limit Vₙ, as set forth in equation (39), below.

$${I}_{qn} = \frac{{V}_{dcn} ( {ω}_{e} {L}_{d n} sin {δ}_{n} + R cos {δ}_{n} )}{{R}^{2} + {ω}_{e}^{2} {L}_{qn}^{2} {L}_{dn}^{2}} \qquad ( 37 )$$

$${I}_{dn} = \frac{{V}_{dcn} ( - {ω}_{e} {L}_{qn} cos {δ}_{n} + R sin {δ}_{n} )}{{R}^{2} + {ω}_{e}^{2} {L}_{qn}^{2} {L}_{dn}^{2}} \qquad ( 38 )$$

$${T}_{eN} = 1.5 pp [ ( 0.5 * ( {L}_{qn} - {L}_{dn} ) {I}_{dn} {I}_{qn} ) ] \qquad ( 39 )$$

The system and method of the present disclosure may then compute the negative virtual voltage-limit-based maximum positive torque T_{epkNP} and the negative virtual voltage-limit-based maximum negative torque T_{epkNN}, each based on the torque T_{eN} corresponding to the negative virtual voltage limit Vₙ, and in accordance with equations (40) and (41), below.

$${T}_{epkNP} = max ( {T}_{eN} ) \qquad ( 40 )$$

$${T}_{epkNN} = min ( {T}_{eN} ) \qquad ( 41 )$$

The system and method of the present disclosure may also compute a total positive peak torque value T_{epkP} and a total negative peak torque value T_{epkN}, in accordance with equations (42) and (43), below:

$${T}_{epkP} = {T}_{epkUP} + {T}_{epkNP} \qquad ( 42 )$$

$${T}_{epkN} = {T}_{epkUN} + {T}_{epkNN} \qquad ( 43 )$$

TORQUE COMMAND LIMITING—The system and method of the present disclosure may also limit an initial motor torque command

$${T}_{e}^{*} ,$$

such as the motor torque command

$${T}_{e}^{*}$$

from the motion controller 80, based on the torque capability computed previously. For example, the system and method may compute a limited torque command

$${T}_{elim}^{*}$$

based on the initial motor torque command

$${T}_{e}^{*} ,$$

limited by the total positive peak torque value T_{epkP} and the total negative peak torque value T_{epkN}, and as set forth in equation (44), below:

$${T}_{elim}^{*} = \{ \begin{matrix}min ( {T}_{e}^{*} , {T}_{epkP} ) , if {T}_{e}^{*} > 0 \\ max ( {T}_{e}^{*} , {T}_{epkN} )\end{matrix} \qquad ( 44 )$$

VIRTUAL MACHINE TORQUE COMMAND LIMITING—The system and method of the present disclosure may also further limit the initial motor torque command

$${T}_{e}^{*}$$

based on the limited torque command

$${T}_{elim}^{*} ,$$

the torque command is further limited for P-side and N-side considering the individual capabilities of P-side and N-side machines. Typically for a surface permanent magnet (SPM) type of machine, there is no electromagnetic torque generated for the N-side. A positive virtual machine torque command

$${T}_{ePlim}^{*}$$

and a negative virtual machine torque command

$${T}_{eNlim}^{*}$$

may be determined as set forth in equations (45) and (46), respectively, below:

$${T}_{ePlim}^{*} = \{ \begin{matrix}{T}_{elim}^{*} , if {T}_{elim}^{*} \leq {T}_{epkUP} ‖ {T}_{elim}^{*} > {T}_{epkUP} \\ {T}_{epkN} , if {T}_{e}^{*} > 0 \\ {T}_{epkUN}\end{matrix} \qquad ( 45 )$$

$${T}_{eNlim}^{*} = \{ \begin{matrix}0 , if {T}_{elim}^{*} \leq {T}_{epkUP} ‖ {T}_{elim}^{*} > {T}_{epkUN} \\ {T}_{elim}^{*} - {T}_{epkUP} , if {T}_{e}^{*} > 0 \\ {T}_{elim}^{*} - {T}_{epkUN}\end{matrix} \qquad ( 46 )$$

ASSYMETRIC NATURE DETERMINATION—The system and method of the present disclosure may also determine whether asymmetric currents in the two winding sets 62a, 62b would be required to cause the dual wound motor 60 to generate a torque in accordance with initial motor torque command

$${T}_{e}^{*} .$$

The system and method may generate an asymmetric current flag Iₙ, wherein Iₙ=0 represents symmetric operation and Iₙ=1 represents asymmetric operation of the dual wound motor 60. The asymmetric current flag Iₙ may be computed as set forth in equation (47), below:

$${I}_{n} = \{ \begin{matrix}0 , if {T}_{elim}^{*} \leq {T}_{epkLP} ‖ {T}_{elim}^{*} > {T}_{epkLN} \\ 1\end{matrix} \qquad ( 47 )$$

MAXIMUM TORQUE PER AMPERE (SYMMETRIC & ASYMMETRIC)—The system and method of the present disclosure may also include determining an initial minimum p-side current I_{dpmin}, I_{qpmin} using a maximum torque per ampere (MTPA) technique. The initial minimum p-side current I_{dpmin}, I_{qpmin} includes a d-axis component I_{dpmin} and a q-axis component I_{qpmin}. A current search for minimum losses may be conducted on the P-side. Since there are no voltage constraints in this case, the MTPA region does not exhibit asymmetry, allowing the N-side currents to be assumed to be zero. The MTPA technique may include sweeping the P-side d-axis current I_{dp} from 0 to I_{dpmax}, calculating the p-side q-axis current I_{qp} using T_{ePlim}, where I_{dpmax} is a maximum P-side d-axis current, which may be a given multiple of a maximum motor current or a demagnetization limit current of the given electric machine. The MTPA technique may also determine a P-side total current Iₘₚ based on a combination of the P-side d-axis current I_{dp} and the P-side q-axis current I_{qp}.

MAXIMUM TORQUE PER VOLTAGE (MTPV)—The system and method of the present disclosure may also include determining final P-side currents I_{dpfinal}, I_{qpfinal} and final N-side currents I_{dnfinal}, I_{qnfinal} in accordance with a voltage constraint. The MTPV computation is divided into two regions. In a first region, symmetric current commands are generated while adhering to the voltage constraint. In the second region, asymmetric current commands are generated to meet the same voltage constraint.

Initially, voltage commands based on MTPA currents are calculated and compared against the available voltage limit for symmetric operation. If the voltage constraint is satisfied and the asymmetric current flag Iₙ was determined to be 0, these commands are used as the final current commands. If the voltage constraint is not met and the asymmetric current flag Iₙ was determined to be 0, a search is performed to find a current combination that satisfies the voltage constraint.

In the second region, where the asymmetric current flag Iₙ is non-zero, the N-side voltage command is determined, indicating how much deviation exists from the voltage limit. Based on this, N-side virtual current commands are generated to satisfy the N-side voltage constraint and produce the corresponding N-side virtual machine torque. The details of the MTPV implementation are shown below.

VOLTAGE LIMIT CURRENT COMMAND SEARCH (SYMMETRIC)—Case (1): Determine Vₘₚ using I_{dpmin} and I_{qpmin}. If Vₘₚ≤V_{pL}, then set the final virtual current commands I_{dpfinal}, I_{qpfinal}, I_{dnfinal}, I_{qnfinal} in accordance with equation set (48):

$$\begin{matrix}{I}_{dpfinal} = {I}_{dpmin} \\ {I}_{qpfinal} = {I}_{qpmin} \\ {I}_{dnfinal} = 0 \\ {I}_{qnfinal} = 0\end{matrix} \qquad ( 48 )$$

Case (2): Determine Vₘₚ using I_{dpmin} and I_{qpmin}. If Vₘₚ>V_{pL}, and Iₙ=0 then sweep I_{dp} from I_{dpmin} to I_{dpmax} and find a combination of symmetric P-side currents

$${I}_{dp}^{sym} , {I}_{qp}^{sym}$$

such that V_{pL}−Vₘₚ=0. The final virtual current commands I_{dpfinal}, I_{qpfinal}, I_{dnfinal}, I_{qnfinal} may then be determined as shown in equation set (49):

$$\begin{matrix}{I}_{dpfinal} = {I}_{dp}^{sym} \\ {I}_{qpfinal} = {I}_{qp}^{sym} \\ {I}_{dnfinal} = 0 \\ {I}_{qnfinal} = 0\end{matrix} \qquad ( 49 )$$

VOLTAGE LIMIT CURRENT COMMAND SEARCH (ASYMMETRIC) Case (3): Determine a P-side total voltage Vₘₚ using I_{dpmin} and I_{qpmin}. If Vₘₚ>V_{pL}, and Iₙ=1, Sweep I_{dp} from I_{dpmin} to I_{dpmax} and calculate I_{qp} based on T_{ePlim} and find a combination of

$${I}_{dp}^{asym} , {I}_{qp}^{asym}$$

such that V_{pL}−Vₘₚ is maximized. Thus, an N-side total required voltage V_{mnreq} may be calculated as set forth in equation (50), below:

$${V}_{mnreq} = \vert {V}_{pL} - {V}_{mp} \vert \qquad ( 50 )$$

A range of values for the N-side total current Iₘₙ (I_{mnMin} to I_{mnMax}) may be computed based on the N-side total required voltage V_{mnreq} and using the following equations (51)-(65):

$${V}_{mn}^{2} = {V}_{dn}^{2} + {V}_{qn}^{2} \qquad ( 51 )$$

$${V}_{mn}^{2} = {( {RI}_{dn} + {ω}_{e} {L}_{qn} {I}_{qn} )}^{2} + {( {RI}_{qn} - {ω}_{e} {L}_{dn} {I}_{dn} )}^{2} \qquad ( 52 )$$

$${I}_{dn} = {I}_{mn} sin {α}_{n} \qquad ( 53 )$$

$${I}_{qn} = {I}_{mn} cos {α}_{n} \qquad ( 54 )$$

$${L}_{qn} = {L}_{on} + {L}_{Δ n} \qquad ( 55 )$$

$${L}_{dn} = {L}_{on} - {L}_{Δ n} \qquad ( 56 )$$

$${L}_{on} = \frac{{L}_{qn} + {L}_{dn}}{2} \qquad ( 57 )$$

$${L}_{Δ n} = \frac{{L}_{qn} - {L}_{dn}}{2} \qquad ( 58 )$$

$${V}_{mn}^{2} = {I}_{mn}^{2} ( {R}^{2} + {ω}_{e}^{2} ( {L}_{on}^{2} + {L}_{Δ n}^{2} ) + 2 {ω}_{e} {L}_{Δ n} {Z}_{0} sin ( 2 {α}_{n} + {ϕ}_{0} ) ) \qquad ( 59 )$$

$${Z}_{0} = \sqrt{{R}^{2} + {ω}_{e}^{2} {L}_{on}^{2}} \qquad ( 60 )$$

$${ϕ}_{0} = {tan}^{- 1} ( \frac{{ω}_{e} {L}_{on}}{R} ) \qquad ( 61 )$$

$${I}_{mn}^{2} = \frac{{V}_{mn}^{2}}{( {R}^{2} + {ω}_{e}^{2} ( {L}_{on}^{2} + {L}_{Δ n}^{2} ) + 2 {ω}_{e} {L}_{Δ n} {Z}_{0} sin ( 2 {α}_{n} + {ϕ}_{0} ) )} \qquad ( 62 )$$

$${Z}_{in} ( {α}_{n} ) = \sqrt{( {R}^{2} + {ω}_{e}^{2} ( {L}_{on}^{2} + {L}_{Δ n}^{2} ) + 2 {ω}_{e} {L}_{Δ n} {Z}_{0} sin ( 2 {α}_{n} + {ϕ}_{0} ) )} \qquad ( 63 )$$

$${I}_{mn} = sign ( {T}_{cmd} ) * sign ( {V}_{n} ) * \frac{\vert {V}_{mn} \vert}{{Z}_{in} ( {α}_{n} )} \qquad ( 64 )$$

$$\vert {V}_{mn} \vert \leq {V}_{dcn} = \vert {V}_{dc 1} - {V}_{dc 2} \vert \qquad ( 65 )$$

where L_{qn}, L_{dn}, Lₒₙ, and L_{Δn} represent q-axis inductance, d-axis inductance, average inductance, and differential inductance, respectively, and each for the negative virtual machine 172b; where Z₀, φ₀, αₙ, Zᵢₙ(αₙ), and Iₘₙ are nominal impedance, impedance angle, current angle, impedance based on current angle, and peak current, respectively, and each for the negative virtual machine 172b.

Minimum and maximum values for the total N-side input impedance Zᵢₙ and the N-side total current Iₘₙ may each be determined as a function of the N-side current angle αₙ, as set forth in Table 1, below:

TABLE 1

| αₙ | Zᵢₙ (αₙ) | Iₘₙ (αₙ) | Note |
|---|---|---|---|
| $\frac{1}{2} ( \frac{π}{2} - {ϕ}_{0} )$ | $\sqrt{{R}^{2} + {ω}_{e}^{2} ( {L}_{on}^{2} + {L}_{Δ n}^{2} ) + 2 {ω}_{e} {L}_{Δ n} {Z}_{0}}$ | $\sqrt{{R}^{2} + {ω}_{e}^{2} ( {L}_{on}^{2} + {L}_{Δ n}^{2} ) + 2 {ω}_{e} {L}_{Δ n} {Z}_{0}}$ | Minimum |
| $\frac{1}{2} ( \frac{3 π}{2} - {ϕ}_{0} )$ | $\sqrt{{R}^{2} + {ω}_{e}^{2} ( {L}_{on}^{2} + {L}_{Δ n}^{2} ) - 2 {ω}_{e} {L}_{Δ n} {Z}_{0}}$ | $\sqrt{{R}^{2} + {ω}_{e}^{2} ( {L}_{on}^{2} + {L}_{Δ n}^{2} ) - 2 {ω}_{e} {L}_{Δ n} {Z}_{0}}$ | Maximum |

Once the range of values for the total N-side current Iₘₙ, i.e., I_{mnMin} to I_{mnMax} is determined, take I_{mnMin} and sweep the N-side current angle αₙ from (−90° to 90°) to figure out a combination of asymmetric N-side currents

$${I}_{dp}^{asym} , {I}_{qp}^{asym}$$

such that T_{eN}=T_{eNlim} and Vₘₙ=V_{mnreq}. Combinations of the asymmetric N-side currents

$${I}_{dp}^{asym} , {I}_{qp}^{asym}$$

may be calculated for the entire range of values of the total N-side current Iₘₙ to find values of the N-side asymmetric currents

$${I}_{dp}^{asym} , {I}_{qp}^{asym}$$

where T_{eN}=T_{eNlim} and the N-side total voltage Vₘₙ=the N-side total required voltage V_{mnreq}. Hence, the final virtual current commands I_{dpfinal}, I_{qpfinal}, I_{dnfinal}, I_{qnfinal} may be determined as set forth in equation set (66):

$$\begin{matrix}{I}_{dpfinal} = {I}_{dpmin} \\ {I}_{qpfinal} = {I}_{qpmin} \\ {I}_{dnfinal} = 0 \\ {I}_{qnfinal} = 0\end{matrix} \qquad ( 48 )$$

INVERSE SYMMETRIC ASYMMETRIC TRANSFORM—An inverse transformation may be used to compute the current commands

$${I}_{d 1}^{*} , {I}_{q 1}^{*} , {I}_{d 2}^{*} , {I}_{q 2}^{*}$$

for each of the winding sets 62a, 62b of the dual wound motor 60, as shown in equation set (67), below:

$$\begin{matrix}{I}_{d 1}^{*} = \frac{{I}_{dpfinal} + {I}_{dnfinal}}{2} \\ {I}_{q 1}^{*} = \frac{{I}_{qpfinal} + {I}_{qpfinal}}{2} \\ {I}_{d 2}^{*} = \frac{{I}_{dpfinal} - {I}_{dnfinal}}{2} \\ {I}_{q 2}^{*} = \frac{{I}_{qpfinal} - {I}_{qnfinal}}{2}\end{matrix} \qquad ( 67 )$$

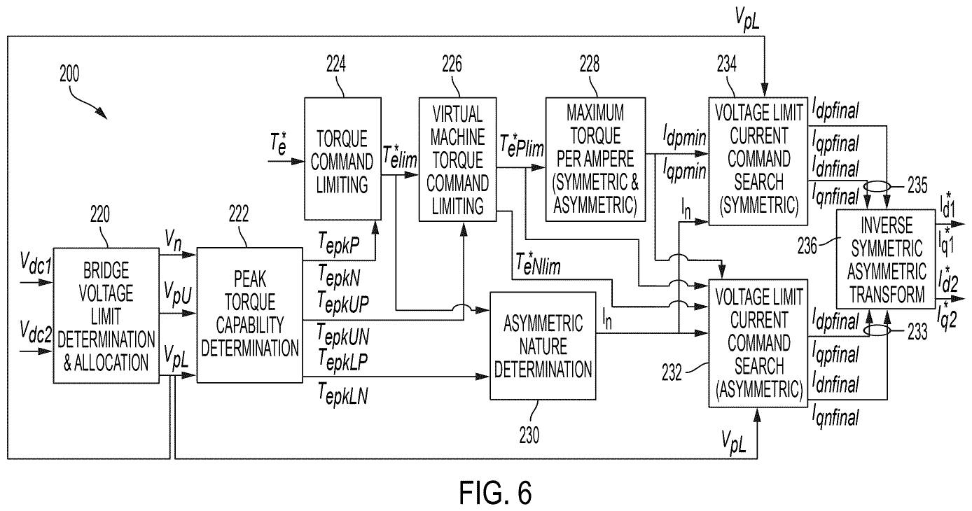

FIG. 6 is a block diagram showing a motor controller 200 for a dual wound synchronous machine (DWSM), according to the principles of the present disclosure. The motor controller 200 of FIG. 6 may describe functionality of the first and second current reference calculators 72a, 72b. The motor controller 200 implements a technique for determining current commands for each ECU utilizing the maximum DC voltage available to each ECU. The determination of current commands is obtained by considering the two halves of the dual wound PMSM 60 as a full virtual machine via a transformation of 2 half machines to one full machine.

The motor controller 200 includes a bridge voltage limit calculator 220 that takes, as inputs, signals representing the first DC supply voltage V_{dc1}, and the second DC supply voltage V_{dc2}. The bridge voltage limit calculator 220 generates, as outputs, signals representing a positive virtual upper voltage limit V_{pU} and a positive virtual lower voltage limit V_{pL}, each representing voltage limits of the positive virtual machine 172a. The bridge voltage limit calculator 220 also generates a negative virtual voltage limit Vₙ of the negative virtual machine 172b. The negative virtual voltage limit Vₙ of the negative virtual machine 172b may represent an upper voltage limit, and the negative virtual machine 172b may have a lower voltage limit of zero volts.

The motor controller 200 also includes a peak torque capability calculator 222 that takes, as inputs, signals from the bridge voltage limit calculator 220 and representing the positive virtual upper voltage limit V_{pU}, the positive virtual lower voltage limit V_{pL}, and the negative virtual voltage limit Vₙ. The peak torque capability calculator 222 generates, as outputs, the total positive peak torque value T_{epkP}, a total negative peak torque value T_{epkN}, the positive virtual upper-voltage-limit-based maximum positive torque T_{epkUP}, the positive virtual upper-voltage-limit-based maximum negative torque T_{epkUN}, the positive virtual lower-voltage-based maximum positive torque T_{epkLP}, and the positive virtual lower-voltage-based maximum negative torque T_{epkLN}.

The peak torque capability calculator 222 may compute the positive virtual upper-voltage-limit-based maximum positive torque T_{epkUP} and the positive virtual upper-voltage-limit-based maximum negative torque T_{epkUN}, each based on the positive virtual upper voltage limit V_{pU}, and as described, above. The peak torque capability calculator 222 may also compute the positive virtual lower-voltage-based maximum positive torque T_{epkLP} and the positive virtual lower-voltage-based maximum negative torque T_{epkLN}, each based on the positive virtual lower voltage limit V_{pL}, and as described, above. The peak torque capability calculator 222 may also compute the positive virtual total peak torque T_{epkP} based the positive virtual upper-voltage-limit-based maximum positive torque T_{epkUP} and further based on the negative virtual voltage limit Vₙ, as described, above. The peak torque capability calculator 222 may also compute the negative virtual total peak torque T_{epkN} based the positive virtual upper-voltage-limit-based maximum negative torque T_{epkUN}, and further based on the negative virtual voltage limit Vₙ, as described, above.

The motor controller 200 also includes a torque command limiter 224 that takes, as inputs, the total positive peak torque value T_{epkP} and the total negative peak torque value T_{epkN} from the peak torque capability calculator 222, and the initial torque command

$${T}_{e}^{*} .$$

The torque command limiter 224 generates, as an output, the limited torque command

$${T}_{elim}^{*} .$$

The torque command limiter 224 may determine the limited torque command

$${T}_{elim}^{*}$$

based on the initial torque command

$${T}_{e}^{*} ,$$

the total positive peak torque value T_{epkP}, and the total negative peak torque value T_{epkN}, as described, above.

The motor controller 200 also includes a virtual machine torque limiter 226 that takes, as inputs, the positive virtual upper-voltage-limit-based maximum positive torque T_{epkUP} and the positive virtual upper-voltage-limit-based maximum negative torque T_{epkUN} from the peak torque capability calculator 222, and the limited torque command

$${T}_{elim}^{*}$$

from the torque command limiter 224. The virtual machine torque limiter 226 generates, as outputs, the positive virtual machine torque command

$${T}_{ePlim}^{*}$$

and the negative virtual machine torque command

$${T}_{eNlim}^{*} .$$

The virtual machine torque limiter 226 may determine the positive virtual machine torque command

$${T}_{ePlim}^{*}$$

and the negative virtual machine torque command

$${T}_{eNlim}^{*}$$

based on the positive virtual upper-voltage-limit-based maximum positive torque T_{epkUP}, the positive virtual upper-voltage-limit-based maximum negative torque T_{epkUN}, and the limited torque command

$${T}_{eNlim}^{*} ,$$

as described, above.

The motor controller 200 also includes a maximum torque per ampere (MTPA) calculator 228 that takes, as inputs, the positive virtual machine torque command

$${T}_{ePlim}^{*}$$

from the virtual machine torque limiter 226, and which generates, as outputs, the initial minimum p-side current I_{dpmin}, I_{qpmin}. The MTPA calculator 228 may determine the initial minimum p-side current I_{dpmin}, I_{qpmin} as described, above.

The motor controller 200 also includes an asymmetric nature adjudicator 230 that generates the asymmetric current flag Iₙ representing symmetric or asymmetric operation of the dual wound motor 60. The asymmetric nature adjudicator 230 takes, as inputs, the positive virtual lower-voltage-based maximum positive torque T_{epkLP} and the positive virtual lower-voltage-based maximum negative torque T_{epkLN} from the peak torque capability calculator 222, and the limited torque command

$${T}_{elim}^{*}$$

from the torque command limiter 224. The asymmetric nature adjudicator may generate the asymmetric current flag Iₙ based on the positive virtual lower-voltage-based maximum positive torque T_{epkLP}, the positive virtual lower-voltage-based maximum negative torque T_{epkLN}, and the limited torque command

$${T}_{elim}^{*} ,$$

as described, above.

The motor controller 200 also includes an asymmetric voltage limit current command generator 232 and a symmetric voltage limit current command generator 234. Each of the asymmetric voltage limit current command generator 232 and a symmetric voltage limit current command generator 234 may determine values of the final current commands I_{dpfinal}, I_{qpfinal}, I_{dnfinal}, I_{qnfinal}.

The asymmetric voltage limit current command generator 232 takes, as inputs, the positive virtual lower voltage limit V_{pL}, the asymmetric current flag Iₙ, the positive virtual machine torque command

$${T}_{ePlim}^{*} ,$$

and the negative virtual machine torque command

$${T}_{eNlim}^{*} .$$

The asymmetric voltage limit current command generator 232 generates a set of final asymmetric motor current commands 233, which include values of the final virtual current commands I_{dpfinal}, I_{qpfinal}, I_{dnfinal}, and I_{qnfinal}. The set of final asymmetric motor current commands 233 may be determined based on the positive virtual lower voltage limit V_{pL}, the asymmetric current flag Iₙ, the positive virtual machine torque command

$${T}_{ePlim}^{*} ,$$

and the negative virtual machine torque command

$${T}_{eNlim}^{*}$$

as described, above.

The symmetric voltage limit current command generator 234 takes, as inputs, the positive virtual lower voltage limit V_{pL}, the asymmetric current flag Iₙ, and the initial minimum p-side current I_{dpmin}, I_{qpmin}. The symmetric voltage limit current command generator 234 generates a set of final symmetric motor current commands 235, which include values of the final virtual current commands I_{dpfinal}, I_{qpfinal}, I_{dnfinal}, and I_{qnfinal}. The set of final symmetric motor current commands 235 may be determined based on the positive virtual lower voltage limit V_{pL}, the asymmetric current flag Iₙ, and the initial minimum p-side current I_{dpmin}, I_{qpmin} as described, above.

The motor controller 200 also includes an inverse transformation 236 that generates the final current commands

$${I}_{d 1}^{*} , {I}_{q 1}^{*} , {I}_{d 2}^{*} , {I}_{q 2}^{*}$$

for the winding sets 62a, 62b of the dual wound motor 60. The inverse transformation 236 takes, as inputs, the final virtual current commands I_{dpfinal}, I_{qpfinal}, I_{dnfinal}, and I_{qnfinal} from the asymmetric voltage limit current command generator 232 and the symmetric voltage limit current command generator 234. The inverse transformation 236 may calculate the final current commands

$${I}_{d 1}^{*} , {I}_{q 1}^{*} , {I}_{d 2}^{*} , {I}_{q 2}^{*}$$

based on the final virtual current commands I_{dpfinal}, I_{qpfinal}, and I_{dnfinal}, I_{qnfinal} as described, above.

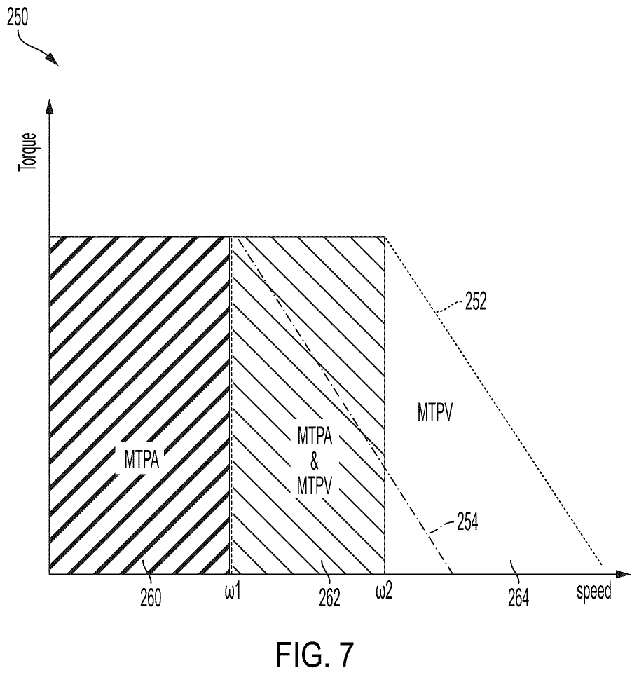

FIG. 7 shows a graph of torque as a function of speed and showing various control regimes and for a dual wound motor operated in a so-called first quadrant, with torque and speed each in a positive direction. FIG. 7 may be useful as background and for understanding the different control regimes of the present disclosure. FIG. 7 includes a first plot 252 representing a torque/speed curve of a PMSM driven by an inverter supplied by a first DC supply voltage V_{dc1}. FIG. 7 also includes a second plot 254 representing a torque/speed curve of the PMSM driven by an inverter supplied by a second DC supply voltage V_{dc2} that is lower than the first DC supply voltage V_{dc1}.

The graph of FIG. 7 includes a first region 260 for speeds up to a first speed ω₁ and in which both the first plot 252 and the second plot 254 are equal. A driver of the dual wound motor 60 fed by the DC voltage sources 82a, 82b and having the DC supply voltages V_{dc1}, V_{dc2} of the operating in this first region 260 may be operated with symmetric currents, which are the same for each of the winding sets 62a, 62b of the dual wound motor 60. The symmetric currents may be generated using a MTPA technique. The graph of FIG. 7 also includes a second region 262 for speeds between the first speed ω₁ and up to a second speed ω₂ and in which both the first plot 252 and the second plot 254 are unequal, but where the first plot 252 maintains a maximum torque value. In this second region 262, the driver of the dual wound motor 60 may be operated using a combination of symmetric currents, and asymmetric currents which are different for each of the winding sets 62a, 62b of the dual wound motor 60. The symmetric currents may be generated using a MTPA technique, and the asymmetric currents may be generated using a MTPV technique. The graph of FIG. 7 also includes a third region 264 for speeds greater than the second speed ω₂, and in which both the first plot 252 and the second plot 254 are less than a maximum torque value. In this third region 264, the driver of the dual wound motor 60 asymmetric currents may be required to operate the dual wound motor 60. The asymmetric currents may be generated using a MTPV technique.

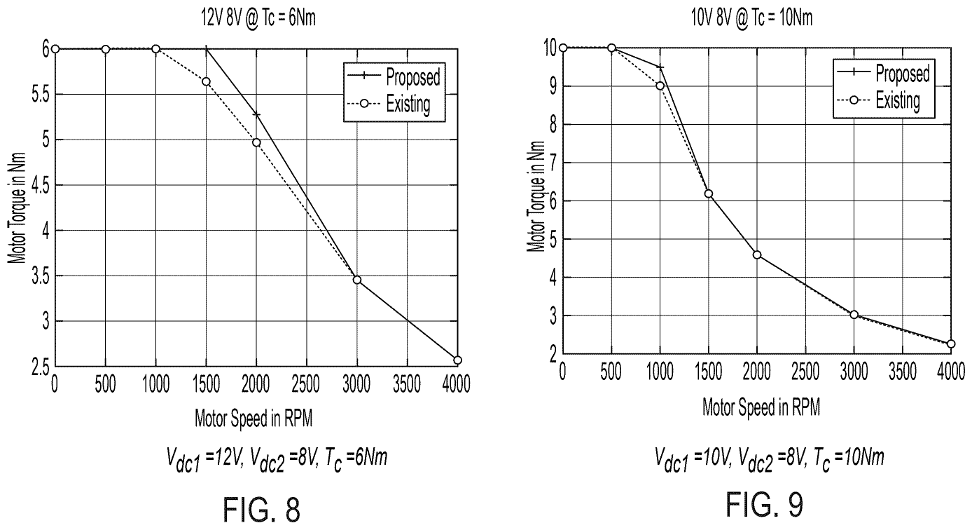

FIG. 8 shows a graph of torque as a function of speed for a DWSM with different supply voltages of 12 VDC and 8 VDC, and a 6 Newton-Meter (Nm) torque command, using both a conventional control technique, labeled “Existing” and a control technique according to the principles of the present disclosure, labeled “Proposed”.

FIG. 9 shows a graph of torque as a function of speed for a DWSM with different supply voltages of 10 VDC and 8 VDC, and a 10 Nm torque command, using both a conventional control technique, labeled “Existing” and a control technique according to the principles of the present disclosure, labeled “Proposed”.

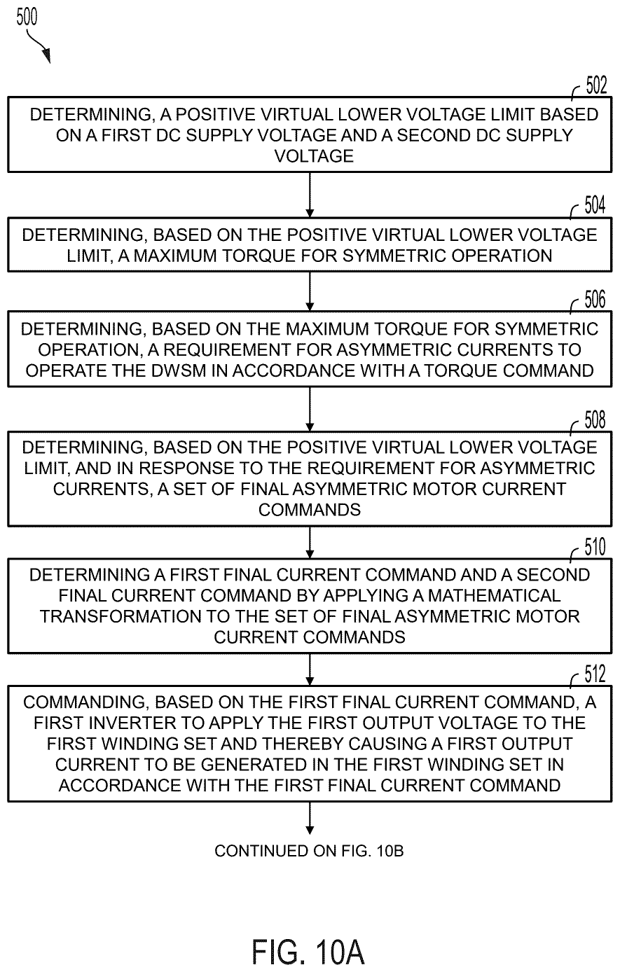

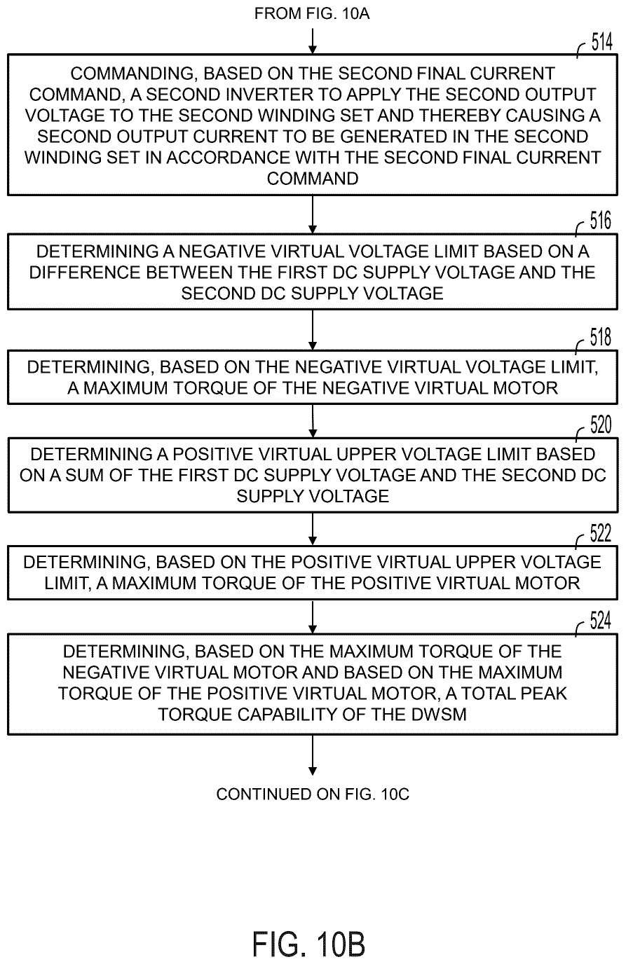

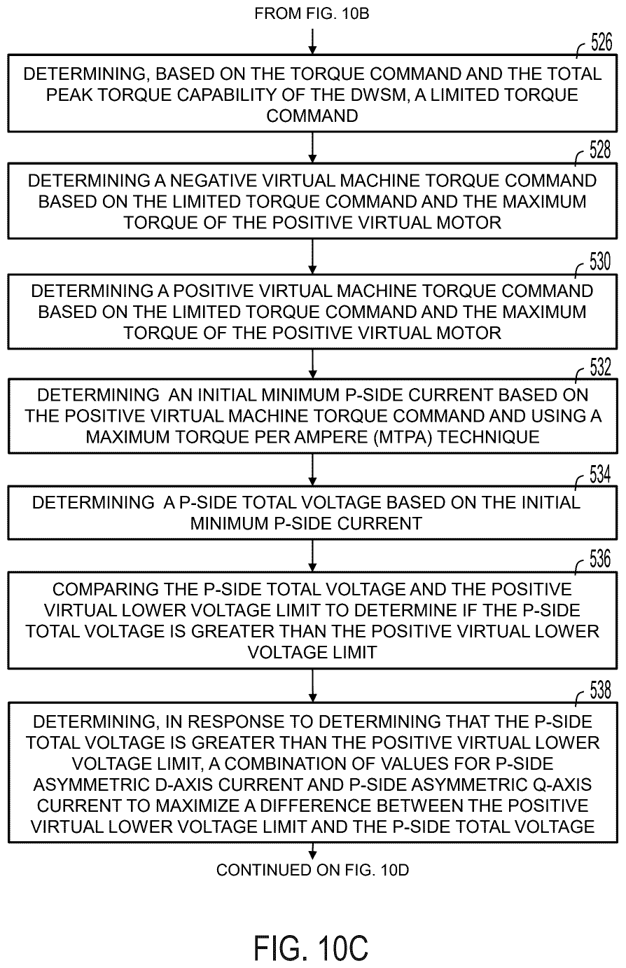

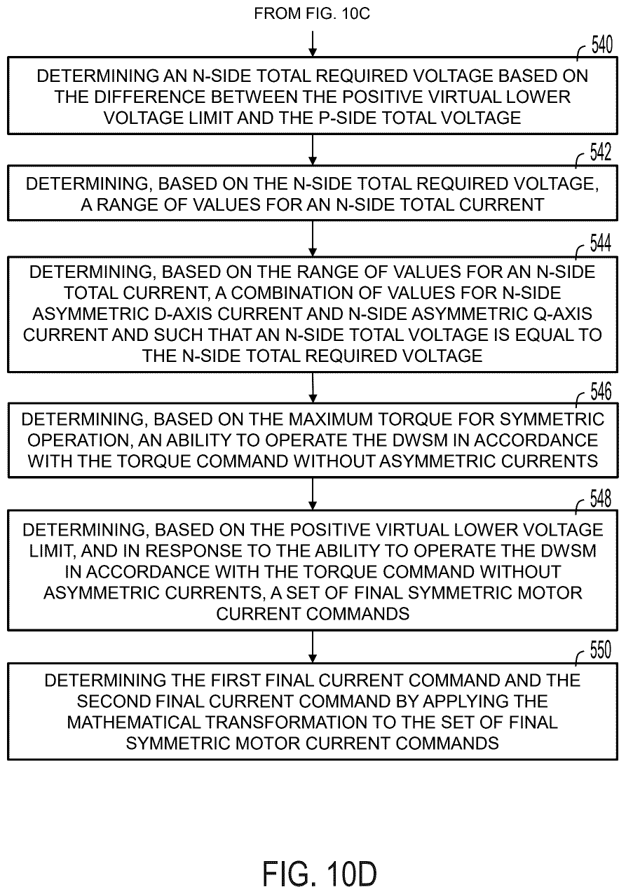

FIGS. 10A-10D show a flow diagram illustrating a method 500 for controlling a dual wound synchronous machine (DWSM), also called a dual wound motor 60, having a first winding set 62a and a second winding set 62b according to the principles of the present disclosure. The method 500 can be performed by the controller 16 or either or both of the ECUs 57, 58, in accordance with some embodiments of the present disclosure. As can be appreciated in light of the disclosure, the order of operation within the method is not limited to the sequential execution as illustrated in FIGS. 10A-10D, but may be performed in one or more varying orders as applicable and in accordance with the present disclosure.

The method 500 includes determining, at 502, a positive virtual lower voltage limit (V_{pL}) based on a first DC supply voltage and a second DC supply voltage. For example, the controller 16 may include hardware and/or software that is configured to implement the bridge voltage limit calculator 220 in order to compute or otherwise determine the positive virtual lower voltage limit (V_{pL}) based on the first DC supply voltage V_{dc1} and the second DC supply voltage V_{dc2} and as set forth in equation (21), above.

The method 500 also includes determining, at 504, based on the positive virtual lower voltage limit (V_{pL}), a maximum torque for symmetric operation (T_{epkLP}, T_{epkLN}). For example, the controller 16 may include hardware and/or software that is configured to implement the peak torque capability calculator 222 to compute or otherwise determine the maximum torque for symmetric operation (T_{epkLP}, T_{epkLN}) based on the positive virtual lower voltage limit (V_{pL}).

The method 500 also includes determining, at 506, based on the maximum torque for symmetric operation (T_{epkLP}, T_{epkLN}), a requirement for asymmetric currents to operate the DWSM in accordance with a torque command

$$( {T}_{e}^{*} ) .$$

For example, the controller 16 may include hardware and/or software that is configured to implement the asymmetric nature adjudicator 230 to generate the asymmetric current flag Iₙ indicating the requirement for asymmetric currents to operate the DWSM in accordance with the torque command

$$( {T}_{e}^{*} ) .$$

The method 500 also includes determining, at 508, based on the positive virtual lower voltage limit (V_{pL}), and in response to the requirement for asymmetric currents, a set of final asymmetric motor current commands. For example, the controller 16 may include hardware and/or software that is configured to implement the asymmetric voltage limit current command generator 232 to calculate or otherwise determine the set of final asymmetric motor current commands 233 based, at least, on the positive virtual lower voltage limit V_{pL}.

The method 500 also includes determining, at 510, a first final current command

$$( {I}_{d 1}^{*} , {I}_{q 1}^{*} )$$

and a second final current command

$$( {I}_{d 2}^{*} , {I}_{q 2}^{*} )$$

by applying a mathematical transformation to the set of final asymmetric motor current commands. For example, the controller 16 may include hardware and/or software that is configured to implement the inverse transformation 236 in order to compute or otherwise determine the final current commands

$${I}_{d 1}^{*} , {I}_{q 1}^{*} , {I}_{d 2}^{*} , {I}_{q 2}^{*}$$

for the winding sets 62a, 62b of the dual wound motor 60 based on the set of final asymmetric motor current commands 233.

In some embodiments, step 510 includes computing the first final current command

$$( {I}_{d 1}^{*} , {I}_{q 1}^{*} )$$

and the second final current command

$$( {I}_{d 2}^{*} , {I}_{q 2}^{*} )$$

in accordance with:

$$\begin{matrix}{I}_{d 1}^{*} = \frac{{I}_{dpfinal} + {I}_{dnfinal}}{2} , \\ {I}_{q 1}^{*} = \frac{{I}_{qpfinal} + {I}_{qnfinal}}{2} , {I}_{d2}^{*} = \frac{{I}_{dpfinal} - {I}_{dnfinal}}{2} , and {I}_{q 2}^{*} = \frac{{I}_{qpfinal} - {I}_{qnfinal}}{2} ,\end{matrix}$$

where

$${I}_{d 1}^{*} and {I}_{q 1}^{*}$$

are d-axis and q-axis components of the first final current command, respectively,

$${I}_{d 2}^{*} and {I}_{q 2}^{*}$$

are d-axis and q-axis components of the second final current command, respectively, I_{dpfinal} and I_{qpfinal} are d-axis and q-axis components of the positive virtual motor current command, respectively, and I_{dnfinal} and I_{qnfinal} are d-axis and q-axis components of the negative virtual motor current command, respectively.

The method 500 also includes commanding, at 512, based on the first final current command

$$( {I}_{d 1}^{*} , {I}_{q 1}^{*} ) ,$$

a first inverter to apply a first output voltage to the first winding set and thereby causing a first output current to be generated in the first winding set in accordance with the first final current command

$$( {I}_{d 1}^{*} , {I}_{q 1}^{*} ) .$$

For example, the controller 16 may include hardware and/or software that is configured to implement the first motor current controller 74a for commanding operation of the first power converter 66a to cause the first power converter 66a to apply the first output voltage V̅₁ to the first winding set 62a.

The method 500 also includes commanding, at 514, based on the second final current command

$$( {I}_{d 2}^{*} , {I}_{q 2}^{*} ) ,$$

a second inverter to apply a second output voltage to the second winding set and thereby causing a second output current to be generated in the second winding set in accordance with the second final current command

$$( {I}_{d 2}^{*} , {I}_{q 2}^{*} ) .$$

For example, the controller 16 may include hardware and/or software that is configured to implement the second motor current controller 74b for commanding operation of the second power converter 66b to cause the second power converter 66b to apply the second output voltage V̅₂ to the second winding set 62b.

The method 500 also includes determining, at 516, a negative virtual voltage limit (Vₙ) based on a difference between the first DC supply voltage and the second DC supply voltage. For example, the controller 16 may include hardware and/or software that is configured to implement the bridge voltage limit calculator 220 in order to compute or otherwise determine the negative virtual voltage limit (Vₙ) based on a difference between the first DC supply voltage V_{dc1} and the second DC supply voltage V_{dc2}, as set forth in equation (22), above.

The method 500 also includes determining, at 518, based on the negative virtual voltage limit (Vₙ), a maximum torque of the negative virtual motor (T_{epkNP}, T_{epkNN}). For example, the controller 16 may include hardware and/or software that is configured to implement the peak torque capability calculator 222 to compute or otherwise determine the maximum torque of the negative virtual motor (T_{epkNP}, T_{epkNN}) based on the negative virtual voltage limit (Vₙ).

The method 500 also includes determining, at 520, a positive virtual upper voltage limit (V_{pU}) based on a sum of the first DC supply voltage and the second DC supply voltage. For example, the controller 16 may include hardware and/or software that is configured to implement the bridge voltage limit calculator 220 to compute or otherwise determine the positive virtual upper voltage limit (V_{pU}) based on the sum of the first DC supply voltage V_{dc1} and the second DC supply voltage V_{dc2} and as set forth in equation (20), above.

The method 500 also includes determining, at 522, based on the positive virtual upper voltage limit (V_{pU}), a maximum torque of the positive virtual motor (T_{epkUP}, T_{epkUN}). For example, the controller 16 may include hardware and/or software that is configured to implement the peak torque capability calculator 222 to compute or otherwise determine the maximum torque of the positive virtual motor (T_{epkUP}, T_{epkUN}) based on the positive virtual upper voltage limit (V_{pU}).

The method 500 also includes determining, at 524, based on the maximum torque of the negative virtual motor (T_{epkNP}, T_{epkNN}) and based on the maximum torque of the positive virtual motor (T_{epkUP}, T_{epkUN}), a total peak torque capability of the DWSM (T_{epkP}, T_{epkN}) in the PN frame. For example, the controller 16 may include hardware and/or software that is configured to implement the peak torque capability calculator 222 to compute or otherwise determine the total peak torque capability of the DWSM (T_{epkP}, T_{epkN}) based on the maximum torque of the negative virtual motor (T_{epkNP}, T_{epkNN}) and based on the maximum torque of the positive virtual motor (T_{epkUP}, T_{epkUN}).

The method 500 also includes determining, at 526, based on the torque command (T*ₑ) and the total peak torque capability of the DWSM (T_{epkP}, T_{epkN}), a limited torque command

$$( {T}_{elim}^{*} ) .$$

For example, the controller 16 may include hardware and/or software that is configured to implement the torque command limiter 224 to compute or otherwise determine the limited torque command

$$( {T}_{elim}^{*} )$$

based on the torque command

$$( {T}_{e}^{*} )$$

and so as not to exceed the total peak torque capability of the DWSM (T_{epkP}, T_{epkN}).

In some embodiments, determining the requirement for asymmetric currents to operate the DWSM in accordance with the torque command

$$( {T}_{e}^{*} )$$

at step 506 further includes comparing the limited torque command

$$( {T}_{elim}^{*} )$$

with the maximum torque for symmetric operation (T_{epkLP}, T_{epkLN}). For example, step 506 may further include comparing the limited torque command

$$( {T}_{elim}^{*} )$$

with the maximum torque for symmetric operation (T_{epkLP}, T_{epkLN}) in order to determine the requirement for asymmetric currents to operate the DWSM in accordance with the torque command

$$( {T}_{e}^{*} ) .$$

The method 500 also includes determining, at 528, a negative virtual machine torque command

$$( {T}_{eNlim}^{*} )$$

based on the limited torque command

$$( {T}_{elim}^{*} )$$

and the maximum torque of the positive virtual motor (T_{epkUP}, T_{epkUN}). For example, the controller 16 may include hardware and/or software that is configured to implement the virtual machine torque limiter 226 for determining the negative virtual machine torque command

$${T}_{eNlim}^{*} .$$

In some embodiments, the controller 16 may compute the negative virtual machine torque command

$$( {T}_{eNlim}^{*} )$$

using equation (46) as described, above.

In some embodiments, determining the set of final asymmetric motor current commands at step 508 includes determining the set of final asymmetric motor current commands further based on the negative virtual machine torque command

$$( {T}_{eNlim}^{*} ) .$$

For example, the asymmetric voltage limit current command generator 232 may be configured to determine the set of final asymmetric motor current commands further based on the negative virtual machine torque command

$$( {T}_{eNlim}^{*} )$$

as described, above.

The method 500 also includes determining, at 530, a positive virtual machine torque command

$$( {T}_{ePlim}^{*} )$$

base on the limited torque command

$$( {T}_{elim}^{*} )$$

and the maximum torque of the positive virtual motor (T_{epkUP}, T_{epkUN}). For example, the controller 16 may include hardware and/or software that is configured to implement the virtual machine torque limiter 226 to compute or otherwise determine the positive virtual machine torque command

$$( {T}_{ePlim}^{*} )$$

based on the limited torque command

$$( {T}_{elim}^{*} )$$

and the maximum torque of the positive virtual motor (T_{epkUP}, T_{epkUN}). For example, the controller 16 may include hardware and/or software that is configured to implement the virtual machine torque limiter 226 for determining the positive virtual machine torque command

$${T}_{ePlim}^{*} .$$

In some embodiments, the controller 16 may compute the positive virtual machine torque command

$${T}_{ePlim}^{*}$$

in accordance with equation (45), as described, above.

In some embodiments, determining the set of final asymmetric motor current commands at step 508 includes determining the set of final asymmetric motor current commands further based on the positive virtual machine torque command

$$( {T}_{ePlim}^{*} ) .$$

For example, the asymmetric voltage limit current command generator 232 may be configured to determine the set of final asymmetric motor current commands further based on the positive virtual machine torque command

$$( {T}_{ePlim}^{*} )$$

as described, above.

The method 500 also includes determining, at 532, an initial minimum p-side current (I_{dpmin}, I_{qpmin}) based on the positive virtual machine torque command

$$( {T}_{ePlim}^{*} )$$

and using a maximum torque per ampere (MTPA) technique. For example, the controller 16 may include hardware and/or software that is configured to implement the MTPA calculator 228 to calculate the initial minimum p-side current (I_{dpmin}, I_{qpmin}) based on the positive virtual machine torque command

$$( {T}_{ePlim}^{*} ) .$$

In some embodiments, determining the set of final asymmetric motor current commands at step 508 includes determining the set of final asymmetric motor current commands further based on the initial minimum p-side current I_{dpmin}, I_{qpmin}. For example, the controller 16 may include hardware and/or software that is configured to implement the asymmetric voltage limit current command generator 232 to determine the final asymmetric motor current commands 233 values of the final current commands I_{dpfinal}, I_{qpfinal}, I_{dnfinal}, I_{qnfinal} further based on the initial minimum p-side current (I_{dpmin}, I_{qpmin}).

The method 500 also includes determining, at 534, a P-side total voltage (Vₘₚ) based on the initial minimum p-side current (I_{dpmin}, I_{qpmin}). For example, the controller 16 may include hardware and/or software that is configured to compute the P-side total voltage (Vₘₚ) using equation (5), and in accordance with the following from equation set (9):

$${V}_{mp} = \sqrt{{\overline{V}}_{dp}^{2} + {\overline{V}}_{qp}^{2}} .$$

The method 500 also includes comparing, at 536, the P-side total voltage (Vₘₚ) and the positive virtual lower voltage limit (V_{pL}) to determine if the P-side total voltage (Vₘₚ) is greater than the positive virtual lower voltage limit (V_{pL}). For example, the controller 16 may include hardware and/or software that is configured to implement the symmetric voltage limit current command generator 234 to determine if the P-side total voltage (Vₘₚ) is greater than the positive virtual lower voltage limit (V_{pL}).

The method 500 also includes determining, at 538, in response to determining that the P-side total voltage (Vₘₚ) is greater than the positive virtual lower voltage limit (V_{pL}), a combination of values for P-side asymmetric d-axis current

$$( {I}_{dp}^{asym} )$$

and P-side asymmetric q-axis current

$$( {I}_{qp}^{asym} )$$

to maximize a difference between the positive virtual lower voltage limit (V_{pL}) and the P-side total voltage (Vₘₚ). For example, the controller 16 may include hardware and/or software that is configured to implement the asymmetric voltage limit current command generator 232 to sweep values of the P-side d-axis current I_{dp} from I_{dpmin} to I_{dpmax} and calculate the P-side q-axis current I_{qp} based on the positive virtual machine torque command

$${T}_{ePlim}^{*}$$

and find a combination of

$${I}_{dp}^{asym} , {I}_{qp}^{asym}$$

such that V_{pL}−Vₘₚ is maximized.

In some embodiments, determining the set of final asymmetric motor current commands at step 508 includes determining the set of final asymmetric motor current commands further based on the combination of values for P-side asymmetric d-axis current

$$( {I}_{dp}^{asym} )$$

and P-side asymmetric q-axis current

$$( {I}_{qp}^{asym} )$$

to maximize a difference between the positive virtual lower voltage limit (V_{pL}) and the P-side total voltage (Vₘₚ). For example, the set of final asymmetric motor current commands may be determined based on the combination of values for P-side asymmetric d-axis current

$$( {I}_{dp}^{asym} )$$

and P-side asymmetric q-axis current

$$( {I}_{qp}^{asym} )$$

as set forth in equation set (66), above.

The method 500 also includes determining, at 540, an N-side total required voltage (V_{mnreq}) based on the difference between the positive virtual lower voltage limit (V_{pL}) and the P-side total voltage (Vₘₚ). For example, the controller 16 may include hardware and/or software that is configured to implement the asymmetric voltage limit current command generator 232 to determine the N-side total required voltage (V_{mnreq}) based on the difference between the positive virtual lower voltage limit (V_{pL}) and the P-side total voltage (Vₘₚ). In some embodiments, the N-side total required voltage (V_{mnreq}) may be calculated as set forth in equation (50), above.

The method 500 also includes determining, at 542, based on the N-side total required voltage (V_{mnreq}), a range of values for an N-side total current (Iₘₙ). For example, the controller 16 may include hardware and/or software that is configured to implement the asymmetric voltage limit current command generator 232 to determine the range of values for the N-side total current (Iₘₙ) based on the N-side total required voltage (V_{mnreq}). In some embodiments, the range of values for the N-side total current (Iₘₙ) may be calculated as set forth in equations (51)-(65), above.

The method 500 also includes determining, at 544, based on the range of values for an N-side total current (Iₘₙ), a combination of values for N-side asymmetric d-axis current

$$( {I}_{dn}^{asym} )$$

and N-side asymmetric q-axis current

$$( {I}_{qn}^{asym} )$$

and such that an N-side total voltage (Vₘₙ) is equal to the N-side total required voltage (V_{mnreq}). For example, the controller 16 may include hardware and/or software that is configured to implement the asymmetric voltage limit current command generator 232 to calculate or otherwise determine the combination of values for N-side asymmetric d-axis current

$$( {I}_{dn}^{asym} )$$

and N-side asymmetric q-axis current

$$( {I}_{qn}^{asym} )$$

and such that an N-side total voltage (Vₘₙ) is equal to the N-side total required voltage (V_{mnreq}). In some embodiments, determining the combination of values for N-side asymmetric d-axis current

$$( {I}_{dn}^{asym} )$$

and N-side asymmetric q-axis current

$$( {I}_{qn}^{asym} )$$

and such that an N-side total voltage (Vₘₙ) is equal to the N-side total required voltage (V_{mnreq}) includes sweeping the N-side current angle αₙ from (−90° to 90°) to determine the combination of asymmetric N-side currents

$${I}_{dn}^{asym} , {I}_{qn}^{asym}$$

such that T_{eN}=T_{eNlim} and Vₘₙ=V_{mnreq}.

In some embodiments, determining the set of final asymmetric motor current commands includes determining the set of final asymmetric motor current commands further based on the combination of values for N-side asymmetric d-axis current

$$( {I}_{dn}^{asym} )$$

and N-side asymmetric q-axis current

$$( {I}_{qn}^{asym} ) .$$

For example, the set of final asymmetric motor current commands 233 may be determined in accordance with equation set (66).

The method 500 also includes determining, at 546, based on the maximum torque for symmetric operation (T_{epkLP}, T_{epkLN}), an ability to operate the DWSM in accordance with the torque command

$$( {T}_{e}^{*} )$$

without asymmetric currents. For example, the controller 16 may include hardware and/or software that is configured to implement the asymmetric nature adjudicator 230 and which may determine the ability to operate the DWSM in accordance with the torque command

$$( {T}_{e}^{*} )$$

without asymmetric currents. In some embodiments, the ability to operate the ability to operate the DWSM in accordance with the torque command

$$( {T}_{e}^{*} )$$

without asymmetric currents may include determining if either of:

$${T}_{elim}^{*} \leq {T}_{epkLP} or {T}_{elim}^{*} > {T}_{epkLN} ,$$

as set forth in equation (47), above.

The method 500 also includes determining, at 548, based on the positive virtual lower voltage limit (V_{pL}), and in response to the ability to operate the DWSM in accordance with the torque command

$$( {T}_{e}^{*} )$$

without asymmetric currents, a set of final symmetric motor current commands. For example, the controller 16 may include hardware and/or software that is configured to implement the symmetric voltage limit current command generator 234 to determine the set of final symmetric motor current commands 235. In some embodiments, the set of final symmetric motor current commands 235 may be calculated as set forth in equation set (49), above.

The method 500 also includes determining, at 550, the first final current command

$$( {I}_{d 1}^{*} , {I}_{q 1}^{*} ) .$$

and the second final current command

$$( {I}_{d 2}^{*} , {I}_{q 2}^{*} )$$

by applying the mathematical transformation to the set of final symmetric motor current commands. For example, the controller 16 may include hardware and/or software that is configured to implement the inverse transformation 236 and using the set of final symmetric motor current commands 235. The set of final symmetric motor current commands 235 may be used for determining the first final current command

$$( {I}_{d 1}^{*} , {I}_{q 1}^{*} )$$

when the asymmetric nature adjudicator 230 does not indicate a requirement for asymmetric current to operate the DWSM in accordance with the torque command

$$( {T}_{e}^{*} ) .$$

In some embodiments, determining the set of final symmetric motor current commands at step 548 includes determining the set of final symmetric motor current commands further based on the initial minimum p-side current I_{dpmin}, I_{qpmin}. For example, the controller 16 may include hardware and/or software that is configured to implement the symmetric voltage limit current command generator 234 to determine the set of final symmetric motor current commands 235 further based on the initial minimum p-side current (I_{dpmin}, I_{qpmin}).

The set of final asymmetric motor current commands 233 may be used for determining the first final current command

$$( {I}_{d 1}^{*} , {I}_{q 1}^{*} )$$

when the asymmetric nature adjudicator 230 indicates a requirement for asymmetric currents to operate the DWSM in accordance with the torque command

$$( {T}_{e}^{*} ) .$$

Otherwise, the set of final symmetric motor current commands 235 may be used for determining the first final current command

$$( {I}_{d 1}^{*} , {I}_{q 1}^{*} ) .$$

For example, the controller 16 may include hardware and/or software that is configured to implement the inverse transformation 236 to determine the first final current command

$$( {I}_{d 1}^{*} , {I}_{q 1}^{*} ) .$$

based on the final asymmetric motor current commands 233 when the asymmetric current flag Iₙ is asserted, indicating the requirement for asymmetric currents to operate the DWSM in accordance with the torque command

$$( {T}_{e}^{*} ) .$$

The inverse transformation 236 may determine the first final current command

$$( {I}_{d 1}^{*} , {I}_{q 1}^{*} )$$

based on the final symmetric motor current commands 235 when the asymmetric current flag Iₙ is de-asserted, indicating no asymmetric currents necessary to operate the DWSM in accordance with the torque command

$$( {T}_{e}^{*} ) .$$

The present disclosure provides a method of controlling a dual wound synchronous machine (DWSM) having a first winding set and a second winding set. The method comprises: determining a positive virtual lower voltage limit (V_{pL}) based on a first DC supply voltage and a second DC supply voltage; determining, based on the positive virtual lower voltage limit (V_{pL}), a maximum torque for symmetric operation (T_{epkLP}, T_{epkLN}); determining, based on the maximum torque for symmetric operation (T_{epkLP}, T_{epkLN}), a requirement for asymmetric currents to operate the DWSM in accordance with a torque command

$$( {T}_{e}^{*} ) ;$$

determining, based on the positive virtual lower voltage limit (V_{pL}), and in response to the requirement for asymmetric currents, a set of final asymmetric motor current commands; determining a first final current command

$$( {I}_{d 1}^{*} , {I}_{q 1}^{*} )$$

and a second final current command

$$( {I}_{d 2}^{*} , {I}_{q 2}^{*} )$$

by applying a mathematical transformation to the set of final asymmetric motor current commands; commanding, based on the first final current command

$$( {I}_{d 1}^{*} , {I}_{q 1}^{*} ) ,$$

a first inverter to apply the first output voltage to the first winding set and thereby causing a first output current to be generated in the first winding set in accordance with the first final current command

$$( {I}_{d 1}^{*} , {I}_{q 1}^{*} ) ;$$

and commanding, based on the second final current command

$$( {I}_{d 2}^{*} , {I}_{q 2}^{*} ) ,$$

second inverter to apply the second output voltage to the second winding set and thereby causing a second output current to be generated in the second winding set in accordance with the second final current command

$$( {I}_{d 2}^{*} , {I}_{q 2}^{*} ) .$$

In some embodiments, determining the first final current command

$$( {I}_{d 1}^{*} , {I}_{q 1}^{*} )$$

and the second final current command

$$( {I}_{d 2}^{*} , {I}_{q 2}^{*} )$$

by applying the mathematical transformation to the set of final asymmetric motor current commands further includes computing the first final current command

$$( {I}_{d 1}^{*} , {I}_{q 1}^{*} )$$

and the second final current command

$$( {I}_{d 2}^{*} , {I}_{q 2}^{*} )$$

in accordance with:

$${I}_{d 1}^{*} = \frac{{I}_{dpfinal} + {I}_{dnfinal}}{2} , {I}_{q 1}^{*} = \frac{{I}_{qpfinal} + {I}_{qnfinal}}{2} , {I}_{d 2}^{*} = \frac{{I}_{dpfinal} - {I}_{dnfinal}}{2} , and {I}_{q 2}^{*} = \frac{{I}_{qpfinal} - {I}_{qnfinal}}{2} ,$$

where

$${I}_{d 1}^{*} and {I}_{q 1}^{*}$$

are d-axis and q-axis components of the first final current command, respectively,

$${I}_{d 2}^{*} and {I}_{q2}^{*}$$

are d-axis and q-axis components of the second final current command, respectively, I_{dpfinal} and I_{qpfinal} are d-axis and q-axis components of the positive virtual motor current command, respectively, and I_{dnfinal} and I_{qnfinal} are d-axis and q-axis components of the negative virtual motor current command, respectively.

In some embodiments, the method further includes: determining a negative virtual voltage limit (Vₙ) based on a difference between the first DC supply voltage and the second DC supply voltage; determining, based on the negative virtual voltage limit (Vₙ), a maximum torque of the negative virtual motor (T_{epkNP}, T_{epkNN}); determining a positive virtual upper voltage limit (V_{pU}) based on a sum of the first DC supply voltage and the second DC supply voltage; determining, based on the positive virtual upper voltage limit (V_{pU}), a maximum torque of the positive virtual motor (T_{epkUP}, T_{epkUN}); determining, based on the maximum torque of the negative virtual motor (T_{epkNP}, T_{epkNN}) and based on the maximum torque of the positive virtual motor (T_{epkUP}, T_{epkUN}), a total peak torque capability of the DWSM (T_{epkP}, T_{epkN}); and determining, based on the torque command

$$( {T}_{e}^{*} )$$

and the total peak torque capability of the DWSM (T_{epkP}, T_{epkN}), a limited torque command

$$( {T}_{elim}^{*} ) .$$

In some embodiments, determining the requirement for asymmetric currents to operate the DWSM in accordance with the torque command

$$( {T}_{e}^{*} )$$

includes comparing the limited torque command

$$( {T}_{elim}^{*} )$$

with the maximum torque for symmetric operation (T_{epkLP}, T_{epkLN}).

In some embodiments, the method further includes determining a negative virtual machine torque command

$$( {T}_{eNlim}^{*} )$$

based on the limited torque command

$$( {T}_{elim}^{*} )$$

and the maximum torque of the positive virtual motor (T_{epkUP}, T_{epkUN}). In some embodiments, determining the set of final asymmetric motor current commands includes determining the set of final asymmetric motor current commands further based on the negative virtual machine torque command

$$( {T}_{eNlim}^{*} ) .$$

In some embodiments, the method further includes determining a positive virtual machine torque command

$$( {T}_{ePlim}^{*} )$$

based on the limited torque command

$$( {T}_{elim}^{*} )$$

and the maximum torque of the positive virtual motor (T_{epkUP}, T_{epkUN}). In some embodiments, determining the set of final asymmetric motor current commands includes determining the set of final asymmetric motor current commands further based on the positive virtual machine torque command

$$( {T}_{ePlim}^{*} ) .$$

In some embodiments, the method further includes determining a positive virtual machine torque command

$$( {T}_{ePlim}^{*} )$$

based on the limited torque command

$$( {T}_{elim}^{*} )$$

and the maximum torque of the positive virtual motor (T_{epkUP}, T_{epkUN}); and determining an initial minimum p-side current (I_{dpmin}, I_{qpmin}) based on the positive virtual machine torque command

$$( {T}_{ePlim}^{*} )$$

and using a maximum torque per ampere (MTPA) technique. In some embodiments, determining the set of final asymmetric motor current commands includes determining the set of final asymmetric motor current commands further based on the initial minimum p-side current I_{dpmin}, I_{qpmin}.

In some embodiments, the method further includes: determining a P-side total voltage (Vₘₚ) based on the initial minimum p-side current (I_{dpmin}, I_{qpmin}); comparing the P-side total voltage (Vₘₚ) and the positive virtual lower voltage limit (V_{pL}) to determine if the P-side total voltage (Vₘₚ) is greater than the positive virtual lower voltage limit (V_{pL}); and determining, in response to determining that the P-side total voltage (Vₘₚ) is greater than the positive virtual lower voltage limit (V_{pL}), a combination of values for P-side asymmetric d-axis current

$$( {I}_{dp}^{asym} )$$

and P-side asymmetric q-axis current

$$( {I}_{qp}^{asym} )$$

to maximize a difference between the positive virtual lower voltage limit (V_{pL}) and the P-side total voltage (Vₘₚ). In some embodiments, determining the set of final asymmetric motor current commands includes determining the set of final asymmetric motor current commands further based on the combination of values for P-side asymmetric d-axis current

$$( {I}_{dp}^{asym} )$$

and P-side asymmetric q-axis current

$$( {I}_{qp}^{asym} )$$

to maximize a difference between the positive virtual lower voltage limit (V_{pL}) and the P-side total voltage (Vₘₚ).

In some embodiments, the method further includes: determining an N-side total required voltage (V_{mnreq}) based on the difference between the positive virtual lower voltage limit (V_{pL}) and the P-side total voltage (Vₘₚ); determining, based on the N-side total required voltage (V_{mnreq}), a range of values for an N-side total current (Iₘₙ); and determining, based on the range of values for an N-side total current (Iₘₙ), a combination of values for N-side asymmetric d-axis current

$$( {I}_{dn}^{asym} )$$

and N-side asymmetric q-axis current

$$( {I}_{qn}^{asym} )$$

and such that an N-side total voltage (Vₘₙ) is equal to the N-side total required voltage (V_{mnreq}). In some embodiments, determining the set of final asymmetric motor current commands includes determining the set of final asymmetric motor current commands further based on the combination of values for N-side asymmetric d-axis current

$$( {I}_{dn}^{asym} )$$

### and N

$$( {I}_{qn}^{asym} ) .$$

In some embodiments, the method further includes: determining, based on the maximum torque for symmetric operation (T_{epkLP}, T_{epkLN}), an ability to operate the DWSM in accordance with the torque command

$$( {T}_{e}^{*} )$$

without asymmetric currents; determining, based on the positive virtual lower voltage limit (V_{pL}), and in response to the ability to operate the DWSM in accordance with the torque command

$$( {T}_{e}^{*} )$$

without asymmetric currents, a set of final symmetric motor current commands; and determining the first final current command

$$( {I}_{d 1}^{*} , {I}_{q 1}^{*} )$$

and the second final current command

$$( {I}_{d 2}^{*} , {I}_{q 2}^{*} )$$

by applying the mathematical transformation to the set of final symmetric motor current commands.

In some embodiments, the method further includes: determining a positive virtual machine torque command

$$( {T}_{ePlim}^{*} )$$

based on the limited torque command

$$( {T}_{elim}^{*} )$$

and the maximum torque of the positive virtual motor (T_{epkUP}, T_{epkUN}); and determining an initial minimum p-side current I_{dpmin}, I_{qpmin} based on the positive virtual machine torque command

$$( {T}_{ePlim}^{*} )$$

and using a maximum torque per ampere (MTPA) technique. In some embodiments, determining the set of final symmetric motor current commands includes determining the set of final symmetric motor current commands further based on the initial minimum p-side current I_{dpmin}, I_{qpmin}.

The present disclosure also provides a system for controlling a dual wound synchronous machine (DWSM) having a first winding set and a second winding set. The system comprises: a first inverter configured to selectively conduct current from a first DC voltage source having a first DC supply voltage, and to thereby apply a first output voltage to the first winding set of the DWSM; a second inverter configured to selectively conduct current from a second DC voltage source having a second DC supply voltage, and to thereby apply a second output voltage to the second winding set of the DWSM; and a controller. The controller is configured to: determine a positive virtual lower voltage limit (V_{pL}) based on the first DC supply voltage and the second DC supply voltage; determine, based on the positive virtual lower voltage limit (V_{pL}), a maximum torque for symmetric operation (T_{epkLP}, T_{epkLN}); determine, based on the maximum torque for symmetric operation (T_{epkLP}, T_{epkLN}), a requirement for asymmetric currents to operate the DWSM in accordance with a torque command

$$( {T}_{e}^{*} ) ;$$

determine, based on the positive virtual lower voltage limit (V_{pL}), and in response to the requirement for asymmetric currents, a set of final asymmetric motor current commands; determine a first final current command

$$( {I}_{d 1}^{*} , {I}_{q 1}^{*} )$$

and a second final current command

$$( {I}_{d 2}^{*} , {I}_{q 2}^{*} )$$

by applying a mathematical transformation to the set of final asymmetric motor current commands; command, based on the first final current command

$$( {I}_{d 1}^{*} , {I}_{q 1}^{*} ) ,$$

the first inverter to apply the first output voltage to the first winding set and thereby causing a first output current to be generated in the first winding set in accordance with the first final current command

$$( {I}_{d 1}^{*} , {I}_{q 1}^{*} ) ;$$

and command, based on the second final current command

$$( {I}_{d 2}^{*} , {I}_{q 2}^{*} ) ,$$

the second inverter to apply the second output voltage to the second winding set and thereby causing a second output current to be generated in the second winding set in accordance with the second final current command

$$( {I}_{d 2}^{*} , {I}_{q 2}^{*} ) .$$

In some embodiments, determining the first final current command

$$( {I}_{d 1}^{*} , {I}_{q 1}^{*} )$$

and the second final current command

$$( {I}_{d 2}^{*} , {I}_{q 2}^{*} )$$

by applying the mathematical transformation to the set of final asymmetric motor current commands further includes computing the first final current command

$$( {I}_{d 1}^{*} , {I}_{q 1}^{*} )$$

and the second final current command

$$( {I}_{d 2}^{*} , {I}_{q 2}^{*} )$$

in accordance with:

$${I}_{d 1}^{*} = \frac{{I}_{dpfinal} + {I}_{dnfinal}}{2} , {I}_{q 1}^{*} = \frac{{I}_{qpfinal} + {I}_{qnfinal}}{2} , \\ {I}_{d 2}^{*} = \frac{{I}_{dpfinal} - {I}_{dnfinal}}{2} , and {I}_{q 2}^{*} = \frac{{I}_{qpfinal} - {I}_{qnfinal}}{2} ,$$

where

$${I}_{d 1}^{*} and {I}_{q 1}^{*}$$

are d-axis and q-axis components of the first final current command, respectively,

$${I}_{d 2}^{*} and {I}_{q 2}^{*}$$

are d-axis and q-axis components of the second final current command, respectively, I_{dpfinal} and I_{qpfinal} are d-axis and q-axis components of the positive virtual motor current command, respectively, and I_{dnfinal} and I_{qnfinal} are d-axis and q-axis components of the negative virtual motor current command, respectively.

In some embodiments, the controller is further configured to: determine a negative virtual voltage limit (Vₙ) based on a difference between the first DC supply voltage and the second DC supply voltage; determine, based on the negative virtual voltage limit (Vₙ), a maximum torque of the negative virtual motor (T_{epkNP}, T_{epkNN}), determine a positive virtual upper voltage limit (V_{pU}) based on a sum of the first DC supply voltage and the second DC supply voltage; determine, based on the positive virtual upper voltage limit (V_{pU}), a maximum torque of the positive virtual motor (T_{epkUP}, T_{epkUN}); determine, based on the maximum torque of the negative virtual motor (T_{epkNP}, T_{epkNN}) and based on the maximum torque of the positive virtual motor (T_{epkUP}, T_{epkUN}), a total peak torque capability of the DWSM (T_{epkP}, T_{epkN}); and determine, based on the torque command

$$( {T}_{e}^{*} )$$

and the total peak torque capability of the DWSM (T_{epkP}, T_{epkN}), a limited torque command

$$( {T}_{elim}^{*} ) .$$

In some embodiments, determining the requirement for asymmetric currents to operate the DWSM in accordance with the torque command

$$( {T}_{e}^{*} )$$

includes comparing the limited torque command

$$( {T}_{elim}^{*} )$$

with the maximum torque for symmetric operation (T_{epkLP}, T_{epkLN}).

In some embodiments, the controller is further configured to determine a negative virtual machine torque command

$$( {T}_{eNlim}^{*} )$$

based on the limited torque command

$$( {T}_{elim}^{*} )$$

and the maximum torque of the positive virtual motor (T_{epkUP}, T_{epkUN}). In some embodiments, determining the set of final asymmetric motor current commands includes determining the set of final asymmetric motor current commands further based on the negative virtual machine torque command

$$( {T}_{eNlim}^{*} ) .$$

In some embodiments, the controller is further configured to determine a positive virtual machine torque command

$$( {T}_{ePlim}^{*} )$$

based on the limited torque command

$$( {T}_{elim}^{*} )$$

and the maximum torque of the positive virtual motor (T_{epkUP}, T_{epkUN}). In some embodiments, determining the set of final asymmetric motor current commands includes determining the set of final asymmetric motor current commands further based on the positive virtual machine torque command

$$( {T}_{ePlim}^{*} ) .$$

In some embodiments, the controller is further configured to: determine a positive virtual machine torque command

$$( {T}_{ePlim}^{*} )$$

based on the limited torque command

$$( {T}_{elim}^{*} )$$

and the maximum torque of the positive virtual motor (T_{epkUP}, T_{epkUN}); and determine an initial minimum p-side current (I_{dpmin}, I_{qpmin}) based on the positive virtual machine torque command

$$( {T}_{ePlim}^{*} )$$

and using a maximum torque per ampere (MTPA) technique. In some embodiments, determining the set of final asymmetric motor current commands includes determining the set of final asymmetric motor current commands further based on the initial minimum p-side current I_{dpmin}, I_{qpmin}.

In some embodiments, the controller is further configured to: determine a P-side total voltage (Vₘₚ) based on the initial minimum p-side current (I_{dpmin}, I_{qpmin}); compare the P-side total voltage (Vₘₚ) and the positive virtual lower voltage limit (V_{pL}) to determine if the P-side total voltage (Vₘₚ) is greater than the positive virtual lower voltage limit (V_{pL}); and determine, in response to determining that the P-side total voltage (Vₘₚ) is greater than the positive virtual lower voltage limit (V_{pL}), a combination of values for P-side asymmetric d-axis current

$$( {I}_{dp}^{asym} )$$

and P-side asymmetric q-axis current

$$( {I}_{qp}^{asym} )$$

to maximize a difference between the positive virtual lower voltage limit (V_{pL}) and the P-side total voltage (Vₘₚ). In some embodiments, determining the set of final asymmetric motor current commands includes determining the set of final asymmetric motor current commands further based on the combination of values for P-side asymmetric d-axis current

$$( {I}_{dp}^{asym} )$$

and P-side asymmetric q-axis current

$$( {I}_{qp}^{asym} )$$

to maximize a difference between the positive virtual lower voltage limit (V_{pL}) and the P-side total voltage (Vₘₚ).

In some embodiments, the controller is further configured to: determine an N-side total required voltage (V_{mnreq}) based on the difference between the positive virtual lower voltage limit (V_{pL}) and the P-side total voltage (Vₘₚ); determine, based on the N-side total required voltage (V_{mnreq}), a range of values for an N-side total current (Iₘₙ); and determine, based on the range of values for an N-side total current (Iₘₙ), a combination of values for N-side asymmetric d-axis current

$$( {I}_{dn}^{asym} )$$

an N-side asymmetric q-axis current

$$( {I}_{q n}^{asym} )$$

and such that an N-side total voltage (Vₘₙ) is equal to the N-side total required voltage (V_{mnreq}). In some embodiments, determining the set of final asymmetric motor current commands includes determining the set of final asymmetric motor current commands further based on the combination of values for N-side asymmetric d-axis current

$$( {I}_{dn}^{asym} )$$

and N-side asymmetric q-axis current

$$( {I}_{qn}^{asym} ) .$$

In some embodiments, the controller is further configured to: determine, based on the maximum torque for symmetric operation (T_{epkLP}, T_{epkLN}), an ability to operate the DWSM in accordance with the torque command

$$( {T}_{e}^{*} )$$

without asymmetric currents; determine, based on the positive virtual lower voltage limit (V_{pL}), and in response to the ability to operate the DWSM in accordance with the torque command

$$( {T}_{e}^{*} )$$

without asymmetric currents, a set of final symmetric motor current commands; and determine the first final current command

$$( {I}_{d 1}^{*} , {I}_{q 1}^{*} )$$

and the second final current command

$$( {I}_{d 2}^{*} , {I}_{q 2}^{*} )$$

by applying the mathematical transformation to the set of final symmetric motor current commands.

In some embodiments, the controller is further configured to: determine a positive virtual machine torque command

$$( {T}_{ePlim}^{*} )$$

based on the limited torque command

$$( {T}_{elim}^{*} )$$

and the maximum torque of the positive virtual motor (T_{epkUP}, T_{epkUN}); and determine an initial minimum p-side current I_{dpmin}, I_{qpmin} based on the positive virtual machine torque command

$$( {T}_{ePlim}^{*} )$$

and using a maximum torque per ampere (MTPA) technique. In some embodiments, determining the set of final symmetric motor current commands includes determining the set of final symmetric motor current commands further based on the initial minimum p-side current I_{dpmin}, I_{qpmin}.

The above discussion is meant to be illustrative of the principles and various embodiments of the present disclosure. Numerous variations and modifications will become apparent to those skilled in the art once the above disclosure is fully appreciated. It is intended that the following claims be interpreted to embrace all such variations and modifications.

The word “example” is used herein to mean serving as an example, instance, or illustration. Any aspect or design described herein as “example” is not necessarily to be construed as preferred or advantageous over other aspects or designs. Rather, use of the word “example” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” throughout is not intended to mean the same embodiment or implementation unless described as such.

Implementations the systems, algorithms, methods, instructions, etc., described herein can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors, or any other suitable circuit. In the claims, the term “processor” should be understood as encompassing any of the foregoing hardware, either singly or in combination. The terms “signal” and “data” are used interchangeably.

As used herein, the term module can include a packaged functional hardware unit designed for use with other components, a set of instructions executable by a controller (e.g., a processor executing software or firmware), processing circuitry configured to perform a particular function, and a self-contained hardware or software component that interfaces with a larger system. For example, a module can include an application specific integrated circuit (ASIC), a Field Programmable Gate Array (FPGA), a circuit, digital logic circuit, an analog circuit, a combination of discrete circuits, gates, and other types of hardware or combination thereof. In other embodiments, a module can include memory that stores instructions executable by a controller to implement a feature of the module.

Further, in one aspect, for example, systems described herein can be implemented using a general-purpose computer or general-purpose processor with a computer program that, when executed, carries out any of the respective methods, algorithms, and/or instructions described herein. In addition, or alternatively, for example, a special purpose computer/processor can be utilized which can contain other hardware for carrying out any of the methods, algorithms, or instructions described herein.

Further, all or a portion of implementations of the present disclosure can take the form of a computer program product accessible from, for example, a computer-usable or computer-readable storage media 13. A computer-usable or computer-readable storage media 13 can include any device that can, for example, tangibly contain, store, communicate, or transport the program for use by or in connection with any processor. The medium can be, for example, an electronic, magnetic, optical, electromagnetic, or a semiconductor device. Other suitable mediums are also available. When computer program code stored on the computer-readable storage media 13 is loaded into and executed by a computer or controller, the computer becomes an apparatus for practicing the invention. At least a portion of the implementations of the present disclosure may also be embodied in the form of computer program code as a data signal 15, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

It will be appreciated that the use of first and second or other similar nomenclature for denoting similar items is not intended to specify or imply any particular order unless otherwise stated.

The above-described embodiments, implementations, and aspects have been described in order to allow easy understanding of the present disclosure and do not limit the present disclosure. On the contrary, the disclosure is intended to cover various modifications and equivalent arrangements included within the scope of the appended claims, which scope is to be accorded the broadest interpretation to encompass all such modifications and equivalent structure as is permitted under the law.

Having thus described the invention, it is claimed:

1. A method of controlling a dual wound synchronous machine (DWSM) having a first winding set and a second winding set, the method comprising:
determining a positive virtual lower voltage limit (V_{pL}) based on a first DC supply voltage and a second DC supply voltage;
determining, based on the positive virtual lower voltage limit (V_{pL}), a maximum torque for symmetric operation (T_{epkLP}, T_{epkLN});
determining, based on the maximum torque for symmetric operation (T_{epkLP}, T_{epkLN}), a requirement for asymmetric currents to operate the DWSM in accordance with a torque command
$$( {T}_{e}^{*} ) ;$$
determining, based on the positive virtual lower voltage limit (V_{pL}), and in response to the requirement for asymmetric currents, a set of final asymmetric motor current commands;
determining a first final current command
$$( {I}_{d 1}^{*} , {I}_{q 1}^{*} )$$
and a second final current command
$$( {I}_{d 2}^{*} , {I}_{q 2}^{*} )$$
by applying a mathematical transformation to the set of final asymmetric motor current commands;
commanding, based on the first final current command
$$( {I}_{d 1}^{*} , {I}_{q 1}^{*} ) ,$$
a first inverter to apply a first output voltage to the first winding set and thereby causing a first output current to be generated in the first winding set in accordance with the first final current command
$$( {I}_{d 1}^{*} , {I}_{q 1}^{*} ) ;$$
and
commanding, based on the second final current command
$$( {I}_{d 2}^{*} , {I}_{q 2}^{*} ) ,$$
a second inverter to apply a second output voltage to the second winding set and thereby causing a second output current to be generated in the second winding set in accordance with the second final current command
$$( {I}_{d 2}^{*} , {I}_{q 2}^{*} ) .$$

2. The method of claim 1, wherein determining the first final current command
$$( {I}_{d 1}^{*} , {I}_{q 1}^{*} )$$
and the second final current command
$$( {I}_{d 2}^{*} , {I}_{q 2}^{*} )$$
by applying the mathematical transformation to the set of final asymmetric motor current commands further includes computing the first final current command
$$( {I}_{d 1}^{*} , {I}_{q 1}^{*} )$$
and the second final current command
$$( {I}_{d 2}^{*} , {I}_{q 2}^{*} )$$
in accordance with:
$${I}_{d 1}^{*} = \frac{{I}_{dpfinal} + {I}_{dnfinal}}{2} , {I}_{q 1}^{*} = \frac{{I}_{qpfinal} + {I}_{qnfinal}}{2} , \\ {I}_{d 2}^{*} = \frac{{I}_{dpfinal} - {I}_{dnfinal}}{2} , and {I}_{q 2}^{*} = \frac{{I}_{qpfinal} - {I}_{qnfinal}}{2} ,$$
where
$${I}_{d 1}^{*} and {I}_{q 1}^{*}$$
are d-axis and q-axis components of the first final current command, respectively,
$${I}_{d 2}^{*} and {I}_{q 2}^{*}$$
are d-axis and q-axis components of the second final current command, respectively, I_{dpfinal} and I_{qpfinal} are d-axis and q-axis components of the positive virtual motor current command, respectively, and I_{dnfinal} and I_{qnfinal} are d-axis and q-axis components of the negative virtual motor current command, respectively.

3. The method of claim 1, further comprising:
determining a negative virtual voltage limit (Vₙ) based on a difference between the first DC supply voltage and the second DC supply voltage;
determining, based on the negative virtual voltage limit (Vₙ), a maximum torque of the negative virtual motor (T_{epkNP}, T_{epkNN});
determining a positive virtual upper voltage limit (V_{pU}) based on a sum of the first DC supply voltage and the second DC supply voltage;
determining, based on the positive virtual upper voltage limit (V_{pU}), a maximum torque of the positive virtual motor (T_{epkUP}, T_{epkUN});
determining, based on the maximum torque of the negative virtual motor (T_{epkNP}, T_{epkNN}) and based on the maximum torque of the positive virtual motor (T_{epkUP}, T_{epkUN}), a total peak torque capability of the DWSM (T_{epkP}, T_{epkN}); and
determining, based on the torque command
$$( {T}_{e}^{*} )$$
and the total peak torque capability of the DWSM (T_{epkP}, T_{epkN}), a limited torque command
$$( {T}_{elim}^{*} ) ,$$
wherein determining the requirement for asymmetric currents to operate the DWSM in accordance with the torque command
$$( {T}_{e}^{*} )$$
includes comparing the limited torque command
$$( {T}_{elim}^{*} )$$
with the maximum torque for symmetric operation (T_{epkLP}, T_{epkLN}).

4. The method of claim 3, further comprising determining a negative virtual machine torque command
$$( {T}_{eNlim}^{*} )$$
based on the limited torque command
$$( {T}_{elim}^{*} )$$
and the maximum torque of the positive virtual motor (T_{epkUP}, T_{epkUN}), and
wherein determining the set of final asymmetric motor current commands includes determining the set of final asymmetric motor current commands further based on the negative virtual machine torque command
$$( {T}_{eNlim}^{*} ) .$$

5. The method of claim 3, further comprising determining a positive virtual machine torque command
$$( {T}_{ePlim}^{*} )$$
based on the limited torque command
$$( {T}_{elim}^{*} )$$
and the maximum torque of the positive virtual motor (T_{epkUP}, T_{epkUN}) and
wherein determining the set of final asymmetric motor current commands includes determining the set of final asymmetric motor current commands further based on the positive virtual machine torque command
$$( {T}_{ePlim}^{*} ) .$$

6. The method of claim 3, further comprising:
determining a positive virtual machine torque command
$$( {T}_{ePlim}^{*} )$$
based on the limited torque command
$$( {T}_{ellm}^{*} )$$
and the maximum torque of the positive virtual motor (T_{epkUP}, T_{epkUN}); and
determining an initial minimum p-side current (I_{dpmin}, I_{qpmin}) based on the positive virtual machine torque command
$$( {T}_{ePlim}^{*} )$$
and using a maximum torque per ampere (MTPA) technique,
wherein determining the set of final asymmetric motor current commands includes determining the set of final asymmetric motor current commands further based on the initial minimum p-side current I_{dpmin}, I_{qpmin}.

7. The method of claim 6, further comprising:
determining a P-side total voltage (Vₘₚ) based on the initial minimum p-side current (I_{dpmin}, I_{qpmin});
comparing the P-side total voltage (Vₘₚ) and the positive virtual lower voltage limit (V_{pL}) to determine if the P-side total voltage (Vₘₚ) is greater than the positive virtual lower voltage limit (V_{pL}); and
determining, in response to determining that the P-side total voltage (Vₘₚ) is greater than the positive virtual lower voltage limit (V_{pL}), a combination of values for P-side asymmetric d-axis current
$$( {I}_{dp}^{asym} )$$
and P-side asymmetric q-axis current
$$( {I}_{qp}^{asym} )$$
to maximize a difference between the positive virtual lower voltage limit (V_{pL}) and the P-side total voltage (Vₘₚ),
wherein determining the set of final asymmetric motor current commands includes determining the set of final asymmetric motor current commands further based on the combination of values for P-side asymmetric d-axis current
$$( {I}_{dp}^{asym} )$$
and P-side asymmetric q-axis current
$$( {I}_{qp}^{asym} )$$
to maximize a difference between the positive virtual lower voltage limit (V_{pL}) and the P-side total voltage (Vₘₚ).

8. The method of claim 6, further comprising:
determining an N-side total required voltage (V_{mnreq}) based on the difference between the positive virtual lower voltage limit (V_{pL}) and the P-side total voltage (Vₘₚ);
determining, based on the N-side total required voltage (V_{mnreq}), a range of values for an N-side total current (Iₘₙ); and
determining, based on the range of values for an N-side total current (Iₘₙ), a combination of values for N-side asymmetric d-axis current
$$( {I}_{dn}^{asym} )$$
and N-side asymmetric q-axis current
$$( {I}_{qn}^{asym} )$$
and such that an N-side total voltage (Vₘₙ) is equal to the N-side total required voltage (V_{mnreq}),
wherein determining the set of final asymmetric motor current commands includes determining the set of final asymmetric motor current commands further based on the combination of values for N-side asymmetric d-axis current
$$( {I}_{dn}^{asym} )$$
and N-side asymmetric q-axis current
$$( {I}_{qn}^{asym} ) .$$

9. The method of claim 1, further comprising:
determining, based on the maximum torque for symmetric operation (T_{epkLP}, T_{epkLN}), an ability to operate the DWSM in accordance with the torque command
$$( {T}_{e}^{*} )$$
without asymmetric currents;
determining, based on the positive virtual lower voltage limit (V_{pL}), and in response to the ability to operate the DWSM in accordance with the torque command
$$( {T}_{e}^{*} )$$
without asymmetric currents, a set of final symmetric motor current commands; and
determining the first final current command
$$( {I}_{d 1}^{*} , {I}_{q 1}^{*} )$$
and the second final current command
$$( {I}_{d 2}^{*} , {I}_{q 2}^{*} ) .$$
by applying the mathematical transformation to the set of final symmetric motor current commands.

10. The method of claim 9, further comprising:
determining a positive virtual machine torque command
$$( {T}_{ePlim}^{*} )$$
based on the limited torque command
$$( {T}_{elim}^{*} )$$
and the maximum torque of the positive virtual motor (T_{epkUP}, T_{epkUN}); and
determining an initial minimum p-side current I_{dpmin}, I_{qpmin} based on the positive virtual machine torque command
$$( {T}_{ePlim}^{*} )$$
and using a maximum torque per ampere (MTPA) technique,
wherein determining the set of final symmetric motor current commands includes determining the set of final symmetric motor current commands further based on the initial minimum p-side current I_{dpmin}, I_{qpmin}.

11. A system for controlling a dual wound synchronous machine (DWSM) having a first winding set and a second winding set, the system comprising:
a first inverter configured to selectively conduct current from a first DC voltage source having a first DC supply voltage, and to thereby apply a first output voltage to the first winding set of the DWSM;
a second inverter configured to selectively conduct current from a second DC voltage source having a second DC supply voltage, and to thereby apply a second output voltage to the second winding set of the DWSM; and
a controller configured to:
determine a positive virtual lower voltage limit (V_{pL}) based on the first DC supply voltage and the second DC supply voltage;
determine, based on the positive virtual lower voltage limit (V_{pL}), a maximum torque for symmetric operation (T_{epkLP}, T_{epkLN});
determine, based on the maximum torque for symmetric operation (T_{epkLP}, T_{epkLN}), a requirement for asymmetric currents to operate the DWSM in accordance with a torque command
$$( {T}_{e}^{*} ) ;$$
determine, based on the positive virtual lower voltage limit (V_{pL}), and in response to the requirement for asymmetric currents, a set of final asymmetric motor current commands;
determine a first final current command
$$( {I}_{d 1}^{*} , {I}_{q 1}^{*} )$$
and a second final current command
$$( {I}_{d 2}^{*} , {I}_{q 2}^{*} )$$
by applying a mathematical transformation to the set of final asymmetric motor current commands;
command, based on the first final current command
$$( {I}_{d 1}^{*} , {I}_{q 1}^{*} ) ,$$
the first inverter to apply the first output voltage to the first winding set and thereby causing a first output current to be generated in the first winding set in accordance with the first final current command
$$( {I}_{d 1}^{*} , {I}_{q 1}^{*} ) ;$$
and
command, based on the second final current command
$$( {I}_{d 2}^{*} , {I}_{q 2}^{*} ) ,$$
the second inverter to apply the second output voltage to the second winding set and thereby causing a second output current to be generated in the second winding set in accordance with the second final current command
$$( {I}_{d 2}^{*} , {I}_{q 2}^{*} ) .$$

12. The system of claim 11, wherein determining the first final current command
$$( {I}_{d 1}^{*} , {I}_{q 1}^{*} )$$
and the second final current command
$$( {I}_{d 2}^{*} , {I}_{q 2}^{*} )$$
by applying the mathematical transformation to the set of final asymmetric motor current commands further includes computing the first final current command
$$( {I}_{d 1}^{*} , {I}_{q 1}^{*} )$$
and the second final current command
$$( {I}_{d 2}^{*} , {I}_{q 2}^{*} )$$
in accordance with:
$${I}_{d 1}^{*} = \frac{{I}_{dpfinal} + {I}_{dnfinal}}{2} , {I}_{q 1}^{*} = \frac{{I}_{qpfinal} + {I}_{qnfinal}}{2} , {I}_{d 2}^{*} = \frac{{I}_{dpfinal} - {I}_{dnfinal}}{2} , and {I}_{q 2}^{*} = \frac{{I}_{qpfinal} - {I}_{qnfinal}}{2} ,$$
where
$${I}_{d 1}^{*} and {I}_{q 1}^{*}$$
are d-axis and q-axis components of the first final current command, respectively,
$${I}_{d 2}^{*} and {I}_{q 2}^{*}$$
are d-axis and q-axis components of the second final current command, respectively, I_{dpfinal} and I_{qpfinal} are d-axis and q-axis components of the positive virtual motor current command, respectively, and I_{dnfinal} and I_{qnfinal} are d-axis and q-axis components of the negative virtual motor current command, respectively.

13. The system of claim 11, wherein the controller is further configured to:
determine a negative virtual voltage limit (Vₙ) based on a difference between the first DC supply voltage and the second DC supply voltage;
determine, based on the negative virtual voltage limit (Vₙ), a maximum torque of the negative virtual motor (T_{epkNP}, T_{epkNN}),
determine a positive virtual upper voltage limit (V_{pU}) based on a sum of the first DC supply voltage and the second DC supply voltage;
determine, based on the positive virtual upper voltage limit (V_{pU}), a maximum torque of the positive virtual motor (T_{epkUP}, T_{epkUN});
determine, based on the maximum torque of the negative virtual motor (T_{epkNP}, T_{epkNN}) and based on the maximum torque of the positive virtual motor (T_{epkUP}, T_{epkUN}), a total peak torque capability of the DWSM (T_{epkP}, T_{epkN}); and
determine, based on the torque command
$$( {T}_{e}^{*} )$$
and the total peak torque capability of the DWSM (T_{epkP}, T_{epkN}), a limited torque command
$$( {T}_{elim}^{*} ) ,$$
wherein determining the requirement for asymmetric currents to operate the DWSM in accordance with the torque command
$$( {T}_{e}^{*} )$$
includes comparing the limited torque command
$$( {T}_{elim}^{*} )$$
with the maximum torque for symmetric operation (T_{epkLP}, T_{epkLN}).

14. The system of claim 13, wherein the controller is further configured to determine a negative virtual machine torque command
$$( {T}_{eNlim}^{*} )$$
based on the limited torque command
$$( {T}_{elim}^{*} )$$
and the maximum torque of the positive virtual motor (T_{epkUP}, T_{epkUN}), and
wherein determining the set of final asymmetric motor current commands includes determining the set of final asymmetric motor current commands further based on the negative virtual machine torque command
$$( {T}_{eNlim}^{*} ) .$$

15. The system of claim 13, wherein the controller is further configured to determine a positive virtual machine torque command
$$( {T}_{ePlim}^{*} )$$
based on the limited torque command
$$( {T}_{elim}^{*} )$$
and the maximum torque of the positive virtual motor (T_{epkUP}, T_{epkUN}), and
wherein determining the set of final asymmetric motor current commands includes determining the set of final asymmetric motor current commands further based on the positive virtual machine torque command
$$( {T}_{ePlim}^{*} ) .$$

16. The system of claim 13, wherein the controller is further configured to:
determine a positive virtual machine torque command
$$( {T}_{ePlim}^{*} )$$
based on the limited torque command
$$( {T}_{elim}^{*} )$$
and the maximum torque of the positive virtual motor (T_{epkUP}, T_{epkUN}); and
determine an initial minimum p-side current (I_{dpmin}, I_{qpmin}) based on the positive virtual machine torque command
$$( {T}_{ePlim}^{*} )$$
and using a maximum torque per ampere (MTPA) technique,
wherein determining the set of final asymmetric motor current commands includes determining the set of final asymmetric motor current commands further based on the initial minimum p-side current I_{dpmin}, I_{qpmin}.

17. The system of claim 16, wherein the controller is further configured to:
determine a P-side total voltage (Vₘₚ) based on the initial minimum p-side current (I_{dpmin}, I_{qpmin});
compare the P-side total voltage (Vₘₚ) and the positive virtual lower voltage limit (V_{pL}) to determine if the P-side total voltage (Vₘₚ) is greater than the positive virtual lower voltage limit (V_{pL}); and
determine, in response to determining that the P-side total voltage (Vₘₚ) is greater than the positive virtual lower voltage limit (V_{pL}), a combination of values for P-side asymmetric d-axis current
$$( {I}_{dp}^{asym} )$$
and P-side asymmetric q-axis current
$$( {I}_{qp}^{asym} )$$
to maximize a difference between the positive virtual lower voltage limit (V_{pL}) and the P-side total voltage (Vₘₚ),
wherein determining the set of final asymmetric motor current commands includes determining the set of final asymmetric motor current commands further based on the combination of values for P-side asymmetric d-axis current
$$( {I}_{dp}^{asym} )$$
and P-side asymmetric q-axis current
$$( {I}_{qp}^{asym} )$$
to maximize a difference between the positive virtual lower voltage limit (V_{pL}) and the P-side total voltage (Vₘₚ).

18. The system of claim 16, wherein the controller is further configured to:
determine an N-side total required voltage (V_{mnreq}) based on the difference between the positive virtual lower voltage limit (V_{pL}) and the P-side total voltage (Vₘₚ);
determine, based on the N-side total required voltage (V_{mnreq}), a range of values for an N-side total current (Iₘₙ); and
determine, based on the range of values for an N-side total current (Iₘₙ), a combination of values for N-side asymmetric d-axis current
$$( {I}_{dn}^{asym} )$$
and N-side asymmetric q-axis current
$$( {I}_{qn}^{asym} )$$
and such that an N-side total voltage (Vₘₙ) is equal to the N-side total required voltage (V_{mnreq}),
wherein determining the set of final asymmetric motor current commands includes determining the set of final asymmetric motor current commands further based on the combination of values for N-side asymmetric d-axis current
$$( {I}_{dn}^{asym} )$$
and N-side asymmetric q-axis current
$$( {l}_{qn}^{asym} ) .$$

19. The system of claim 11, wherein the controller is further configured to:
determine, based on the maximum torque for symmetric operation (T_{epkLP}, T_{epkLN}), an ability to operate the DWSM in accordance with the torque command
$$( {T}_{e}^{*} )$$
without asymmetric currents;
determine, based on the positive virtual lower voltage limit (V_{pL}), and in response to the ability to operate the DWSM in accordance with the torque command
$$( {T}_{e}^{*} )$$
without asymmetric currents, a set of final symmetric motor current commands; and
determine the first final current command
$$( {I}_{d 1}^{*} , {I}_{q 1}^{*} )$$
and the second final current command
$$( {I}_{d 2}^{*} , {I}_{q 2}^{*} )$$
by applying the mathematical transformation to the set of final symmetric motor current commands.

20. The system of claim 19, wherein the controller is further configured to:
determine a positive virtual machine torque command
$$( {T}_{ePlim}^{*} )$$
based on the limited torque command
$$( {T}_{elim}^{*} )$$
and the maximum torque of the positive virtual motor (T_{epkUP}, T_{epkUN}); and
determine an initial minimum p-side current I_{dpmin}, I_{qpmin} based on the positive virtual machine torque command
$$( {T}_{ePlim}^{*} )$$
and using a maximum torque per ampere (MTPA) technique,
wherein determining the set of final symmetric motor current commands includes determining the set of final symmetric motor current commands further based on the initial minimum p-side current I_{dpmin}, I_{qpmin}.
